(19) United States
(12) Patent Application Publication
(10) Pub. No.: US 2026/0097494 A1
(43) Pub. Date: Apr. 9, 2026

(54) METHOD FOR CONTROLLING ARTICULATED ROBOT AND ROBOT SYSTEM

(71) Applicants: LAUREL PRECISION CO., LTD., Osaka (JP); LAUREL BANK MACHINES CO., LTD., Tokyo (JP)

(72) Inventors: Tomohide HANDA, Tokyo (JP); Hideyuki NAKANISHI, Tokyo (JP)

(73) Assignees: LAUREL PRECISION CO., LTD., Osaka (JP); LAUREL BANK MACHINES CO., LTD., Tokyo (JP)

(21) Appl. No.: 19/416,048

(22) Filed: Dec. 11, 2025

Related U.S. Application Data
(63) Continuation of application No. PCT/JP2024/021407, filed on Jun. 12, 2024.

(30) Foreign Application Priority Data
Jun. 20, 2023 (JP) 2023-100645

(51) Int. Cl. B25J 9/16

(52) U.S. Cl. CPC B25J 9/1653

(57) ABSTRACT

A method for controlling an articulated robot is a method for controlling an articulated robot with L (L is a natural number of seven or more) joints, wherein a controller receives a selected drive mode among a plurality of drive modes, wherein at least one joint of the L joints is associated, as a drive target joint, with each of the plurality of drive modes, executes calculation processing including an inverse kinematics calculation to calculate an amount of displacement of the drive target joint identified based on the selected drive mode from among the L joints, calculates, based on the calculation processing executed, a joint value relating to a state of each of the L joints such that the articulated robot is in a target state, and controls an operation of the articulated robot based on the joint value calculated for each of the L joints.

### CROSS REFERENCE TO RELATED APPLICATIONS

This application is a Continuation Application of PCT Application No. PCT/JP2024/021407, filed on Jun. 12, 2024, and is based on, and claims priority from, Japanese Patent Application No. 2023-100645, filed on Jun. 20, 2023, the entire contents of each of which are incorporated herein by reference.

### BACKGROUND

### Field of the Invention

The present invention relates to methods for controlling articulated robots, to methods for teaching articulated robots, and to robot systems.

### Related Art

Various types of industrial robots are known, such as a cartesian robot that moves along two or three axes perpendicular to one another, a selective compliance articulated robot arm that smoothly moves in a horizontal direction, and a vertical articulated robot that realizes operations similar to operations performable by humans (for example, see Japanese Patent Application, Laid-Open Publication No. 2013-188796, Japanese Patent Application, Laid-Open Publication No. 2016-215371, and Japanese Patent Application, Laid-Open Publication No. S62-74594). For example, a user appropriately selects a robot, which is to be used for performing an operation (work), from among a plurality of types of industrial robots in accordance with the purpose of the work. Recently, uses of robots are increasing, and it is necessary for a single robot to conduct various operations.

### SUMMARY

Thus, an industrial robot is desired in which a single robot can conduct an operation of each of a plurality of types of robots.

A method for controlling an articulated robot according to a preferred aspect of the present invention is a method for controlling an articulated robot with L (L is a natural number of seven or more) joints, comprising receiving, by a computer device, a selected drive mode among a plurality of drive modes, wherein at least one joint of the L joints is associated, as a drive target joint, with each of the plurality of drive modes, executing, by the computer device, calculation processing including an inverse kinematics calculation to calculate an amount of displacement of the drive target joint identified based on the selected drive mode from among the L joints, and calculating, by the computer device and based on the executing the calculation processing, a joint value relating to a state of each of the L joints such that the articulated robot is in a target state, and controlling, by the computer device, an operation of the articulated robot based on the joint value calculated for each of the L joints.

A method for teaching an articulated robot according to a preferred aspect of the present invention is a method for teaching an articulated robot with L (L is a natural number of seven or more) joints, comprising receiving, by a computer device, a selected drive mode among a plurality of drive modes, wherein at least one of the L joints is associated, as a drive target joint, with each of the plurality of drive modes, executing, by the computer device, calculation processing including an inverse kinematics calculation to calculate an amount of displacement of the drive target joint identified based on the selected drive mode from among the L joints, and calculating, by the computer device and based on the executing the calculation processing, a joint value relating to a state of each of the L joints such that the articulated robot is in a target state, and generating, by the computer device, joint state information indicative of the joint value calculated for each of the L joints.

A robot system according to a preferred aspect of the present invention includes an articulated robot including L (L is a natural number of seven or more) joints and including a plurality of drive modes, wherein at least one joint of the L joints is associated, as a drive target joint, with each of the plurality of drive modes, and a controller including an operation controller configured to control an operation of the articulated robot, wherein the operation controller is configured to receive a selected drive mode among the plurality of drive modes, execute calculation processing including an inverse kinematics calculation to calculate an amount of displacement of the drive target joint identified based on the selected drive mode from among the L joints, and calculate, based on the calculation processing executed, a joint value relating to a state of each of the L joints such that the articulated robot is in a target state, and control the operation of the articulated robot based on the joint value calculated for each of the L joints.

A robot system according to another preferred aspect of the present invention includes an articulated robot including L (L is a natural number of seven or more) joints and including a plurality of drive modes, wherein at least one joint of the L joints is associated, as a drive target joint, with each of the plurality of drive modes, and a controller including an operation controller configured to control an operation of the articulated robot, and a display controller configured to display, on a display, a selection screen for selecting a drive mode from among the plurality of drive modes, wherein the operation controller is configured to drive the drive target joint identified based on a drive mode selected via the selection screen to control the operation of the articulated robot such that the articulated robot is in a target state.

According to the present invention, it is possible to provide an industrial robot that can conduct operations of each of a plurality of types of robots.

### BRIEF DESCRIPTION OF THE DRAWINGS

FIG. 1 is an explanatory diagram explaining an outline of a robot system according to an embodiment.

FIG. 2 is an explanatory diagram explaining examples of joint mechanisms.

FIG. 3 is a diagram showing an example of a hardware configuration of a robot controller shown in FIG. 1.

FIG. 4 is an explanatory diagram explaining examples of drive modes of a robot.

FIG. 5 is an explanatory diagram explaining an example of an operation screen.

FIG. 6 is a flowchart showing an example of an operation of the robot controller shown in FIG. 1.

FIG. 7 is a flowchart showing an example of a joint value updating process shown in FIG. 6.

FIG. 8 is an explanatory diagram explaining an example of an operation of the robot system.

FIG. 9 is an explanatory diagram explaining an operation following the operation of the robot system shown in FIG. 8.

FIG. 10 is an explanatory diagram explaining another example of the operation of the robot system.

FIG. 11 is an explanatory diagram explaining an operation following the operation of the robot system shown in FIG. 10.

FIG. 12 is an explanatory diagram explaining an operation following the operation of the robot system shown in FIG. 11.

FIG. 13 is an explanatory diagram explaining an operation following the operation of the robot system shown in FIG. 12.

FIG. 14 is an explanatory diagram explaining another example of the operation of the robot system.

FIG. 15 is an explanatory diagram explaining an operation following the operation of the robot system shown in FIG. 14.

FIG. 16 is an explanatory diagram explaining an operation following the operation of the robot system shown in FIG. 15.

FIG. 17 is an explanatory diagram explaining an example of an end section according to a first modification.

FIG. 18 is an explanatory diagram explaining examples of turning.

### DESCRIPTION OF EMBODIMENTS

With reference to the drawings, embodiments according to the present invention will be described below. It should be noted that in each of the drawings, dimensions and scales of respective elements may differ from those of actual articles. In addition, since the embodiments described below are preferred examples of the present invention, technically preferred various limitations are added thereto; however, the scope of the present invention is not limited to these embodiments unless otherwise stated in the following explanations that the present invention is particularly limited thereto.

### 1. Embodiment

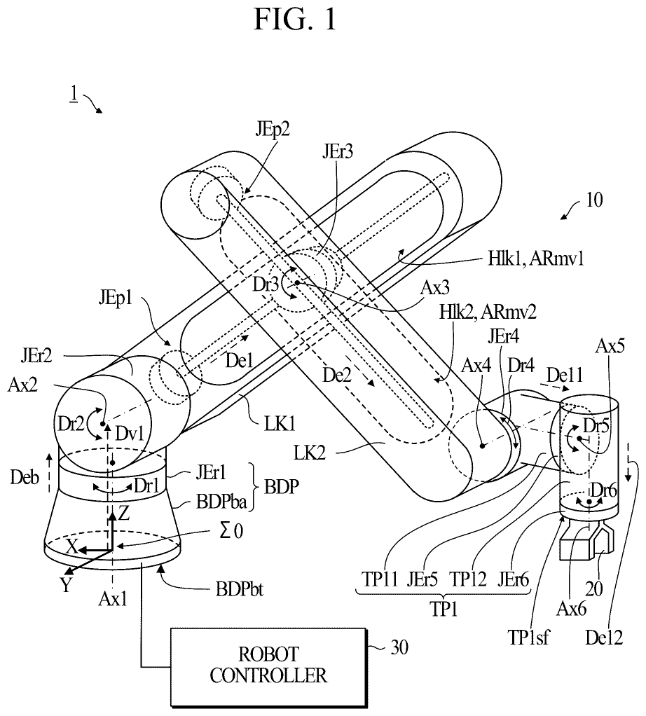

First, an example of an outline of a robot system 1 according to an embodiment will be described with reference to FIG. 1.

FIG. 1 is an explanatory diagram explaining the outline of the robot system 1 according to the embodiment.

It should be noted that in the following, for convenience of explanation, a reference coordinate system Σ0 fixed in a real space is introduced as a base coordinate system for a robot 10. For example, the reference coordinate system Σ0 is a three-axis Cartesian coordinate system, which has an origin at a center of a bottom BDPbt of the robot 10 described below and includes an X-axis, a Y-axis, and a Z-axis perpendicular to one another.

The robot system 1 includes, for example, the robot 10, an end effector 20 attachable to, and detachable from, the robot 10, and a robot controller 30 for controlling operations of the robot 10 and the end effector 20. The robot 10 is an example of “an articulated robot,” and the robot controller 30 is included in examples of “a controller” and “a computer device.”

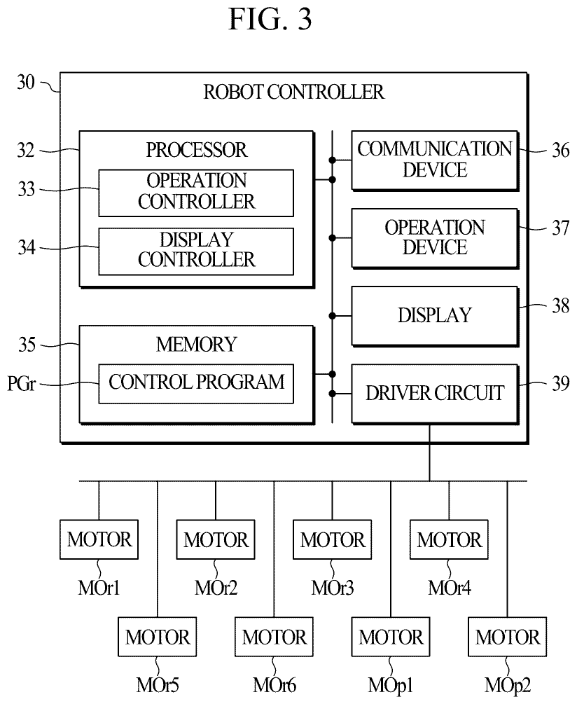

The robot 10 and the robot controller 30 are connected to, and are communicable with, each other by wired connection, for example. It should be noted that connection between the robot 10 and the robot controller 30 may be a wireless connection or may be a connection in which both a wired connection and a wireless connection are used. In addition, the robot controller 30 is communicable with the end effector 20 attached to the robot 10. As the robot controller 30, a freely selected information processor communicable with other devices may be used. It should be noted that a configuration of the robot controller 30 will be described with reference to FIG. 3 described below.

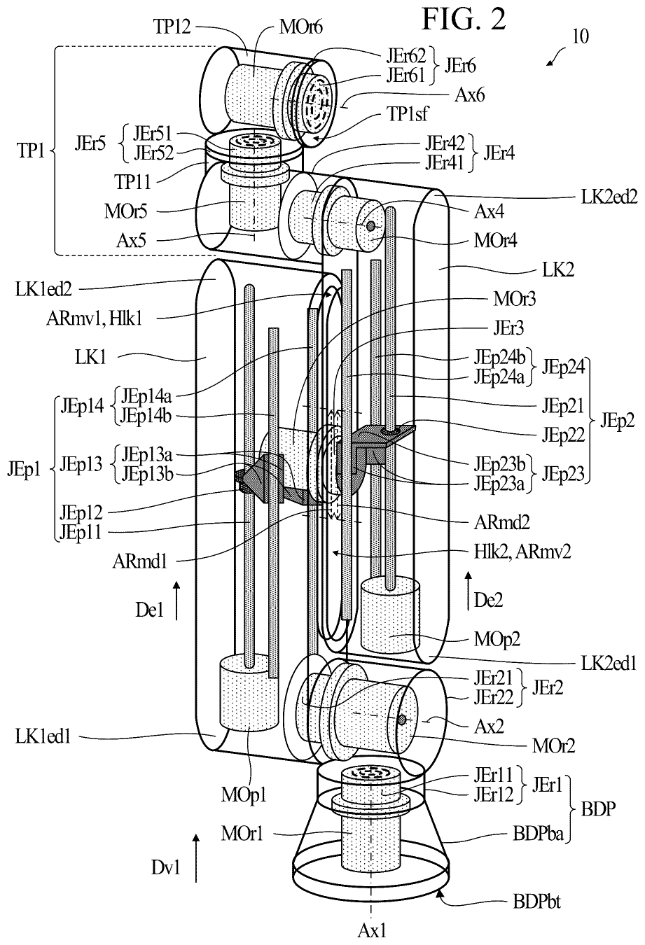

The robot 10 is an articulated robot used for tasks on farms, in factories, and in warehouses, etc., for example. Specifically, the robot 10 is an eight-axis articulated robot in which two joint mechanisms JEp (JEp1 and JEp2) that correspond to prismatic joints are added to a six-axis articulated robot having six joint mechanisms JEr (JEr1, JEr2, JEr3, JEr4, JEr5, and JEr6) that correspond to rotary joints. For example, the robot 10 includes the six joint mechanisms JEr, the two joint mechanisms JEp, a body BDP, two links LK (LK1 and LK2), and an end section TP1. It should be noted that in an example shown in FIG. 1, the joint mechanism JEr1 is included in the body BDP, and the joint mechanisms JEr5 and JEr6 are included in the end section TP1. In addition, the joint mechanism JEp1 is provided in the link LK1, and the joint mechanism JEp2 is provided in the link LK2. In the following, the joint mechanisms JEr and JEp need not be particularly distinguished from each other and may be referred to as joint mechanisms JE. For example, the robot 10 further includes a plurality of motors MO (see FIG. 2) for driving a plurality of joint mechanisms JE. In FIG. 1, for ease of visibility in the drawing, the plurality of motors MO for driving the plurality of joint mechanisms JE, and a reducer, an encoder, etc., provided in each of the plurality of motors MO are omitted. It should be noted that the plurality of joint mechanisms JE is an example of “a plurality of joints.”

The body BDP is an example of a “base.” In addition, the link LK1 is an example of “a first link,” and the link LK2 is an example of “a second link.” Thus, the links LK1 and LK2 correspond to a plurality of links LK. For example, the links LK1 and LK2 connect the body BDP and the end section TP1 to each other.

Here, for example, connection between members includes both direct connection between two members and indirect connection between the two members. The direct connection between the two members includes a state in which the two members are in contact with each other, and a state that can be equated with the state in which the two members are in contact with each other. The state that can be equated with the state in which the two members are in contact with each other is, for example, a state in which one of the two members is fixed to the other with an adhesive, etc. In addition, the indirect connection between the two members means that another member is disposed between the two members.

The joint mechanism JEr1 is an example of “a first drive mechanism,” and the joint mechanism JEr2 is an example of “a second drive mechanism.” The joint mechanism JEr3 is an example of “a third drive mechanism,” and the joint mechanism JEr4 is an example of “a fourth drive mechanism.” In addition, the joint mechanism JEr5 is an example of a “fifth drive mechanism,” and the joint mechanism JEr6 is an example of a “sixth drive mechanism.” In addition, the joint mechanism JEp1 is an example of a “first movement mechanism,” and the joint mechanism JEp2 is an example of a “second movement mechanism.”

The body BDP includes a base part BDPba, which is fixed to a predetermined place such as a floor, and the joint mechanism JEr1 connected to the joint mechanism JEr2, for example. The joint mechanism JEr1 rotates a portion of the body BDP around a rotation axis that is an axis Ax1 perpendicular to the bottom BDPbt of the body BDP. For example, the joint mechanism JEr1 rotates an outer wall of the joint mechanism JEr1 relative to the base part BDPba around the rotation axis that is the axis Ax1, the outer wall of the joint mechanism JEr1 including a portion of the joint mechanism JEr1 connected to the joint mechanism JEr2. In other words, the joint mechanism JEr1 rotates the joint mechanism JEr2 relative to the body BDP around the rotation axis that is the axis Ax1. It should be noted that the axis Ax1 is an example of a “first rotation axis.”

Here, “perpendicular” includes not only exactly perpendicular, but also substantially perpendicular (for example, perpendicular within a margin of error). Similarly, “parallel” described below includes not only exactly parallel, but also substantially parallel (for example, parallel within a margin of error). In FIG. 1, a rotation direction Dr1 indicates a direction of rotation of the portion of the body BDP in a case in which the portion of the body BDP is rotated around the rotation axis that is the axis Ax1.

The joint mechanism JEr2 connects the body BDP and the link LK1 to each other and rotates the link LK1 relative to the body BDP around a rotation axis that is an axis Ax2 parallel to the bottom BDPbt of the body BDP. In FIG. 1, a rotation direction Dr2 indicates a direction of rotation of the link LK1 in a case in which the link LK1 is rotated around the rotation axis that is the axis Ax2. It should be noted that the axis Ax2 is an example of a “second rotation axis.”

The link LK1 is hollow and is provided to be elongated, for example. In addition, the link LK1 includes an opening Hlk1 extending in a direction De1 in which the link LK1 extends.

The opening Hlk1 is provided in a surface of the link LK1 that includes a section facing the link LK2, for example. Within the link LK1, a portion of the joint mechanism JEr3 and the joint mechanism JEp1 are provided. For example, the portion of the joint mechanism JEr3 is disposed within the link LK1, and the remaining portion of the joint mechanism JEr3 protrudes from the opening Hlk1 to the outside of the link LK1. It should be noted that the portion of the joint mechanism JEr3 disposed outside the link LK1 or a part of the portion of the joint mechanism JEr3 disposed outside the link LK1 is disposed within the link LK2 through an opening Hlk2 of the link LK2 described below.

It should be noted that the link LK1 is rotated by the joint mechanism JEr1 relative to the body BDP around the rotation axis that is the axis Ax1, and is rotated by the joint mechanism JEr2 relative to the body BDP around the rotation axis that is the axis Ax2.

The joint mechanism JEr3 connects the link LK1 and the link LK2 to each other and rotates the link LK2 relative to the link LK1 around a rotation axis that is an axis Ax3 perpendicular to the direction De1 in which the link LK1 extends. In FIG. 1, a rotation direction Dr3 indicates a direction of rotation of the link LK2 in a case in which the link LK2 is rotated around the rotation axis that is the axis Ax3. It should be noted that the axis Ax3 is an example of a “third rotation axis.”

The joint mechanism JEp1 moves the joint mechanism JEr3 relative to the link LK1 along the direction De1. By movement of the joint mechanism JEr3 along the direction De1, the link LK2 is moved relative to the link LK1 along the direction De1. It should be noted that in the example shown in FIG. 1, when the joint mechanism JEp1 moves the joint mechanism JEr3 along the direction De1, a portion of the link LK1 that is the opening Hlk1 corresponds to a movement area ARmv1 in which the joint mechanism JEr3 is allowed to be moved.

The link LK2 is hollow and is provided to be elongated, for example. In addition, the link LK2 includes the opening Hlk2 extending in a direction De2 in which the link LK2 extends.

The opening Hlk2 is provided in a surface of the link LK2 that includes a section facing the link LK1, for example. Within the link LK2, a portion of the joint mechanism JEr3 and the joint mechanism JEp2 are provided. For example, the portion of the joint mechanism JEr3 is disposed within the link LK2, and the remaining portion of the joint mechanism JEr3 protrudes from the opening Hlk2 to the outside of the link LK2.

The joint mechanism JEp2 moves the link LK2 relative to the joint mechanism JEr3 along the direction De2 in which the link LK2 extends. As a result, the link LK2 is moved relative to the joint mechanism JEr3 along the direction De2. In other words, the link LK2 is moved relative to the link LK1 along the direction De2.

Thus, the link LK2 is moved by the joint mechanism JEp1 relative to the link LK1 along the direction De1, and is moved by the joint mechanism JEp2 relative to the link LK1 along the direction De2.

Here, movement of the link LK2 relative to the joint mechanism JEr3 may also be described as movement of the joint mechanism JEr3 relative to the link LK2. Thus, the joint mechanism JEp2 may be considered to be a joint mechanism JE that moves the joint mechanism JEr3 relative to the link LK2 along the direction De2. In the example shown in FIG. 1, when the joint mechanism JEp2 moves the joint mechanism JEr3 along the direction De2, a portion of the link LK2 that is the opening Hlk2 corresponds to a movement area ARmv2 in which the joint mechanism JEr3 is allowed to be moved.

The joint mechanism JEr4 connects the link LK2 and the end section TP1 to each other and rotates the end section TP1 relative to the link LK2 around a rotation axis that is an axis Ax4 perpendicular to the direction De2. In FIG. 1, a rotation direction Dr4 indicates a direction of rotation of the end section TP1 in a case in which the end section TP1 is rotated around the rotation axis that is the axis Ax4. It should be noted that the axis Ax4 is an example of a “fourth rotation axis.”

For example, the end effector 20 for holding an object is attached to the end section TP1. For example, the end effector 20 is attached to an end surface TP1sf of the end section TP1. The end section TP1 includes a first portion TP11 connected to the link LK2, a second portion TP12 connected to the first portion TP11, the joint mechanism JEr5, and the joint mechanism JEr6. The first portion TP11 is connected to the link LK2, via the joint mechanism JEr4, for example. As a result, the first portion TP11 is rotated relative to the link LK2 around the rotation axis that is the axis Ax4.

The joint mechanism JEr5 connects the first portion TP11 and the second portion TP12 to each other, and rotates the second portion TP12 relative to the first portion TP11 around a rotation axis that is an axis Ax5 perpendicular to the axis Ax4. In FIG. 1, a rotation direction Dr5 indicates a direction of rotation of the second portion TP12 in a case in which the second portion TP12 is rotated around the rotation axis that is the axis Ax5. It should be noted that the axis Ax5 is an example of a “fifth rotation axis.”

The joint mechanism JEr6 rotates at least a portion of the end section TP1 around a rotation axis that is an axis Ax6 perpendicular to the axis Ax5. In the example shown in FIG. 1, the joint mechanism JEr6 rotates the end surface TP1sf of the end section TP1 around the rotation axis that is the axis Ax6. In other words, the joint mechanism JEr6 rotates a portion of the end section TP1 (the end surface TP1sf), to which the end effector 20 is attached, around the rotation axis that is the axis Ax6. In FIG. 1, a rotation direction Dr6 indicates a direction of rotation of the end surface TP1sf in a case in which the end surface TP1sf is rotated around the rotation axis that is the axis Ax6. It should be noted that the axis Ax6 is an example of a “sixth rotation axis.”

In the example shown in FIG. 1, a front surface of the joint mechanism JEr6 corresponds to the end surface TP1sf. It should be noted that in a configuration in which the joint mechanism JEr6 is included in the second portion TP12, an end surface of the second portion TP12 may be the end surface TP1sf.

In addition, work conducted by the end effector 20 is not limited to holding of objects. As the end effector 20, an appropriate unit (for example, a robot hand, a robot finger, etc.) may be applied in accordance with the purpose of work of the robot 10. In other words, the end effector 20 appropriate for a respective type of work is attached to the end section TP1.

Here, in the present embodiment, rotation around a rotation axis that is an axis having an angle greater than a predetermined angle to a specific direction may be referred to as a “turning” as distinguished from rotation around a rotation axis that is an axis having an angle of the predetermined angle or less to the specific direction. The predetermined angle may be 45°, for example. It should be noted that the predetermined angle is not limited to 45°.

For example, for rotation around a rotation axis that is any one of the axis Ax1 and the axis Ax2, a direction Dv1 perpendicular to the bottom BDPbt of the body BDP corresponds to the specific direction. In this case, the axis Ax1 corresponds to an axis having an angle of the predetermined angle or less to the direction Dv1 perpendicular to the bottom BDPbt of the body BDP, and the axis Ax2 corresponds to an axis having an angle greater than the predetermined angle to the direction Dv1. Thus, rotation of the link LK1 around the rotation axis that is the axis Ax2 corresponds to the turning. It should be noted that in the present embodiment, since the body BDP extends along the direction Dv1 perpendicular to the bottom BDPbt, a direction Deb in which the body BDP extends may be the specific direction.

In addition, for rotation around the rotation axis that is the axis Ax3, the direction De1 in which the link LK1 extends corresponds to the specific direction, and for rotation around the rotation axis that is the axis Ax4, the direction De2 in which the link LK2 extends corresponds to the specific direction. In this case, the axis Ax3 corresponds to an axis having an angle greater than the predetermined angle to the direction De1 in which the link LK1 extends, and the axis Ax4 corresponds to an axis having an angle greater than the predetermined angle to the direction De2 in which the link LK2 extends. Thus, rotation of the link LK2 around the rotation axis that is the axis Ax3 and rotation of the first portion TP11 around the rotation axis that is the axis Ax4 correspond to turnings.

In addition, for rotation around the rotation axis that is the axis Ax5, a direction De11 corresponds to the specific direction, and for rotation around the rotation axis that is the axis Ax6, a direction De12 corresponds to the specific direction. The direction De11 is a direction from an end of the first portion TP11, which is opposite to a predetermined end of the first portion TP11 connected to the joint mechanism JEr5, toward the predetermined end. It should be noted that the direction De11 may be considered to be a direction in which the first portion TP11 extends. In addition, the direction De12 is a direction from an end of the second portion TP12, which is opposite to a predetermined end (an end including the end surface TP1sf) of the second portion TP12 connected to the joint mechanism JEr6, toward the predetermined end. It should be noted that the direction De12 may be considered to be a direction in which the second portion TP12 extends.

When the direction De11 is the specific direction, the axis Ax5 corresponds to an axis having an angle of the predetermined angle or less to the direction De11. Alternatively, when the direction De12 is the specific direction, the axis Ax6 corresponds to an axis having an angle of the predetermined angle or less to the direction De12. It should be noted that in the present embodiment, a case is assumed in which the direction De11 is a direction perpendicular to the axis Ax4 and the direction De12 is a direction perpendicular to the axis Ax5. In this case, the axis Ax5 having an angle of the predetermined angle or less to the direction De11 corresponds to an axis having an angle greater than the predetermined angle to the axis Ax4, and the axis Ax6 having an angle of the predetermined angle or less to the direction De12 corresponds to an axis having an angle greater than the predetermined angle to the axis Ax5.

Thus, in the present embodiment, the respective components (the body BDP, the link LK1, the link LK2, the end section TP1, etc.) of the robot 10 are rotatable around respective rotation axes that are the axes Ax1, Ax2, Ax3, Ax4, Ax5 and Ax6. In this way, in the present embodiment, the robot 10 can conduct an operation that is substantially the same as that of a human being.

For example, the link LK1 between the joint mechanism JEr2 and the joint mechanism JEr3 corresponds to the upper arm, and the link LK2 between the joint mechanism JEr3 and the joint mechanism JEr4 corresponds to the forearm. In addition, the robot 10 can conduct an operation of simulating a human twisting at the waist by the joint mechanism JEr1, and can conduct an operation of simulating turning of a shoulder by the joint mechanism JEr2. In addition, the robot 10 can conduct an operation of simulating turning of an elbow by the joint mechanism JEr3, and can conduct an operation of simulating turning of a wrist by the joint mechanism JEr4. In addition, the robot 10 can conduct an operation of simulating twisting of a wrist by the joint mechanism JEr5, and can conduct an operation of simulating twisting of a fingertip by the joint mechanism JEr6.

Furthermore, in the present embodiment, the joint mechanism JEp1 provided in the link LK1 enables the link LK2 to be moved relative to the link LK1 along the direction De1 in which the link LK1 extends. In addition, in the present embodiment, the joint mechanism JEp2 provided in the link LK2 enables the link LK2 to be moved relative to the link LK1 along the direction De2 in which the link LK2 extends. Thus, in the present embodiment, the joint mechanisms JEp1 and JEp2 enable the end section TP1 of the robot 10 to be easily moved to a vicinity of the body BDP. In addition, in the present embodiment, the joint mechanisms JEp1 and JEp2 can extend a reachable range for the end section TP1 (more specifically, the end surface TP1sf); thus, it is possible to extend a reachable range for the end effector 20 attached to the robot 10.

It should be noted that a configuration of the robot system 1 is not limited to the example shown in FIG. 1. For example, the robot controller 30 may be provided within the robot 10. In addition, in FIG. 1, although it is assumed that the robot 10 is fixed to a predetermined place such as a floor, the robot 10 is not necessarily fixed to the predetermined place, and the robot 10 itself may be moveable. In addition, the base part BDPba of the body BDP may be fixed to the predetermined place such as a floor via the joint mechanism JEr1. In this case, the body BDP may be defined not to include the joint mechanism JEr1. In a configuration in which the base part BDPba is fixed to the predetermined place via the joint mechanism JEr1, the joint mechanism JEr1 may rotate the base part BDPba around the rotation axis that is the axis Ax1. In addition, in a configuration in which the base part BDPba is fixed to the predetermined place via the joint mechanism JEr1, the base part BDPba may be connected to the joint mechanism JEr2.

Next, examples of the joint mechanisms JEp1 and JEp2 will be described with reference to FIG. 2.

FIG. 2 is an explanatory diagram explaining examples of joint mechanisms JE. In FIG. 2, the joint mechanisms JEp1 and JEp2 and the joint mechanism JEr3 are mainly described. In the present embodiment, a case is assumed in which the motor MOr3 for driving the joint mechanism JEr3 is integrally moved with the joint mechanism JEr3. For example, the motor MOr3 may be fixed to the joint mechanism JEr3. First, the joint mechanism JEp1 will be described.

The joint mechanism JEp1 and a motor MOp1 for driving the joint mechanism JEp1 are disposed within the link LK1. For example, the motor MOp1 is provided within the link LK1 at an end LK1ed1, which is close to the body BDP, among two ends LK1ed (LK1ed1 and LK1ed2) of the link LK1. It should be noted that the end LK1ed2 is an end LK1ed, which is far from the body BDP, among the two ends LK1ed of the link Lk1.

The joint mechanism JEp1 includes a thread JEp11 extending along the direction De1, a nut JEp12, a connection JEp13, and a rail JEp14, for example.

An end of the thread JEp11 is attached to the motor MOp1. For example, the thread JEp11 is attached to the motor MOp1 such that a center axis of the thread JEp11 (the center axis along the direction De1) is coincident with a rotation axis of the motor MOp1, and is inserted in the nut JEp12. In addition, with rotation of the motor MOp1, the thread JEp11 is rotated around a rotation axis that is the center axis along the direction De1.

The connection JEp13 includes a slider JEp13a, which is connected to the rail JEp14 to be movable along the direction De1, and a support JEp13b supporting the nut JEp12 and the motor MOr3, for example. For example, the nut JEp12 is fixed to the support JEp13b so as not to rotate together with the thread JEp11. In addition, the motor MOr3 is fixed to the support JEp13b so as to prevent rotation of the motor MOr3 itself.

It should be noted that the slider JEp13a and the support JEp13b are not necessarily strictly distinguished. For example, the motor MOr3 may be fixed to the slider JEp13a. In addition, the nut JEp12 may be fixed to the motor MOr3 not via the support JEp13b. In other words, the nut JEp12 may be connected to the connection JEp13, etc., such that a position of the nut JEp12 relative to the joint mechanism JEr3 remains unchanged. Thus, the nut JEp12 is connected to the joint mechanism JEr3 via the connection JEp13, etc.

The rail JEp14 extends along the direction De1 and includes two rod-shaped members JEp14a and JEp14b disposed parallel to each other. A shape of each of the rod-shaped members JEp14a and JEp14b and a shape of the slider JEp13a are not particularly limited, as long as the slider JEp13a is supported by the rod-shaped members JEp14a and JEp14b to be movable. In other words, a shape of the rail JEp14 is not particularly limited, as long as the connection JEp13 is supported to be movable. The rail JEp14 is disposed between the opening Hlk1 and the thread JEp11 in a direction along the axis Ax2 and is provided within the link LK1, for example. It should be noted that the rail JEp14 is not necessarily disposed between the opening Hlk1 and the thread JEp11 in the direction along the axis Ax2, as long as the joint mechanism JEr3 is movable along the direction De1 in a state in which a portion of the joint mechanism JEr3 protrudes from the opening Hlk1.

Since the nut JEp12 is fixed to the connection JEp13 so as not to rotate together with the thread JEp11, rotation of the thread JEp11 causes the nut JEp12 to be moved relative to the thread JEp11 along the direction De1. As described above, the nut JEp12 is fixed to the connection JEp13, etc., such that the position relative to the joint mechanism JEr3 remains unchanged. In other words, the joint mechanism JEr3 is moved together with the nut JEp12 along the direction De1. For example, with movement of the nut JEp12, the joint mechanism JEr3 is moved relative to the link LK1. Thus, the joint mechanism JEp1 supports the joint mechanism JEr3 that is movable. The movement area ARmv1 (range of movement) of the joint mechanism JEr3 is preferably a movable area in the link LK1 from an area, which is closer to the end LK1ed1 than to the end LK1ed2, to an area, which is closer to the end LK1ed2 than to the end LK1ed1. In this way, a substantial length (a control length) of the link LK1 can be within a range of half of a length of the link LK1 or less and half of the length of the link LK1 or more. The substantial length of the link LK1 is, for example, a length along the direction De1 from the end LK1ed1 (for example, an intersection of the link LK1 and the axis Ax2) to the joint mechanism JEr3 (more exactly, the axis Ax3).

Here, by switching between directions of rotation of the motor MOp1, a direction of movement of the nut JEp12, i.e., a direction of movement of the joint mechanism JEr3 is switched between the direction De1 and a direction opposite to the direction De1. For example, when the motor MOp1 rotates in a first rotation direction, the nut JEp12 is moved in the direction De1, and when the motor MOp1 rotates in a second rotation direction opposite to the first rotation direction, the nut JEp12 is moved in the direction opposite to the direction De1. Next, the joint mechanism JEp2 will be described.

The joint mechanism JEp2 and a motor MOp2 for driving the joint mechanism JEp2 are disposed within the link LK2. For example, the motor MOp2 is provided within the link LK2 at an end LK2ed1, which is far from the end section TP1, among two ends LK2ed (LK2ed1 and LK2ed2) of the link LK2. It should be noted that the end LK2ed2 is an end LK2ed, which is close to the end section TP1, among the two ends LK2ed of the link LK2.

The joint mechanism JEp2 includes a thread JEp21 extending along the direction De2, a nut JEp22, a connection JEp23, and a rail JEp24, for example.

An end of the thread JEp21 is attached to the motor MOp2. For example, the thread JEp21 is attached to the motor MOp2 such that a center axis of the thread JEp21 (the center axis along the direction De2) is coincident with a rotation axis of the motor MOp2, and is inserted in the nut JEp22. In addition, with rotation of the motor MOp2, the thread JEp21 is rotated around a rotation axis that is the center axis along the direction De2.

The connection JEp23 includes a slider JEp23a, which is connected to the rail JEp24 to be movable along the direction De2, and a support JEp23b supporting the nut JEp22 and the joint mechanism JEr3, for example. For example, the nut JEp22 is fixed to the support JEp23b so as not to rotate together with the thread JEp21. In addition, the support JEp23b is connected to the joint mechanism JEr3 so as to rotate around the rotation axis that is the axis Ax3 (not shown in FIG. 2) with rotation of the motor MOr3. In other words, with the rotation of the motor MOr3, the joint mechanism JEr3 rotates the support JEp23b around the rotation axis that is the axis Ax3.

It should be noted that the slider JEp23a and the support JEp23b are not necessarily strictly distinguished. For example, the joint mechanism JEr3 may be fixed to the slider JEp23a. In addition, the nut JEp22 may be fixed to the slider JEp23a. In other words, the nut JEp22 may be connected to the connection JEp23, etc., such that the position relative to the joint mechanism JEr3 remains unchanged. Thus, the nut JEp22 is connected to the joint mechanism JEr3 via the connection JEp23, etc.

The rail JEp24 extends along the direction De2 and includes two rod-shaped members JEp24a and JEp24b disposed parallel to each other. A shape of each of the rod-shaped members JEp24a and JEp24b and a shape of the slider JEp23a are not particularly limited, as long as the slider JEp23a is supported by the rod-shaped members JEp24a and JEp24b to be movable. In other words, a shape of the rail JEp24 is not particularly limited, as long as the connection JEp23 is supported to be movable. The rail JEp24 is disposed between the opening Hlk2 and the thread JEp21 in the direction along the axis Ax2 and is provided within the link LK2, for example. It should be noted that the rail JEp24 is not necessarily disposed between the opening Hlk2 and the thread JEp21 in the direction along the axis Ax2, as long as the joint mechanism JEr3 is movable along the direction De2 in a state in which a portion of the joint mechanism JEr3 protrudes from the opening Hlk2.

Since the nut JEp22 is fixed to the connection JEp23 so as not to rotate together with the thread JEp21, rotation of the thread JEp21 causes the nut JEp22 to be moved relative to the thread JEp21 along the direction De2. As described above, the nut JEp22 is fixed to the connection JEp23, etc., such that the position relative to the joint mechanism JEr3 remains unchanged. In addition, the joint mechanism JEr3 is supported by the joint mechanism JEp1 such that a position of the joint mechanism JEr3 relative to the link LK1 remains unchanged in a case in which the thread JEp11 is not rotated, i.e., in a case in which the motor MOp1 does not rotate. Thus, by movement of the nut JEp22 relative to the thread JEp21, the link LK2 is moved relative to the joint mechanism JEr3 along the direction De2. Thus, the joint mechanism JEp2 supports the link LK2 that is movable. The movement area ARmv2 (range of movement) of the joint mechanism JEr3 is preferably a movable area in the link LK2 from an area, which is closer to the end LK2ed1 than to the end LK2ed2, to an area, which is closer to the end LK2ed2 than to the end LK2ed1. In this way, a substantial length (a control length) of the link LK2 can be within a range of half of a length of the link LK2 or less and half of the length of the link LK2 or more. The substantial length of the link LK2 is, for example, a length along the direction De2 from the joint mechanism JEr3 (more exactly, the axis Ax3) to the end LK2ed2 (for example, an intersection of the link LK2 and the axis Ax4).

It should be noted that the joint mechanism JEr3 is supported by the joint mechanism JEp2 such that the position relative to the link LK2 remains unchanged in a case in which the thread JEp21 is not rotated, i.e., in a case in which the motor MOp2 does not rotate. The joint mechanism JEr3 can turn the link LK2 relative to the link LK1 regardless of the position relative to the link LK1. In addition, the joint mechanism JEr3 can turn the link LK2 relative to the link LK1 regardless of the position relative to the link LK2.

Here, by switching between directions of rotation of the motor MOp2, a direction of movement of the nut JEp22 relative to the thread JEp21, i.e., a direction of movement of the link LK2 is switched between the direction De2 and a direction opposite to the direction De2. For example, when the motor MOp2 rotates in a first rotation direction, the link LK2 is moved in the direction opposite to the direction De2, and when the motor MOp2 rotates in a second rotation direction opposite to the first rotation direction, the link LK2 is moved in the direction De2.

It should be noted that configurations of the joint mechanisms JEp are not limited to examples shown in FIG. 2. For example, as an element of the joint mechanism JEp1, a ball screw may be used that includes a plurality of balls interposed between the thread JEp11 and the nut JEp12. Similarly, as an element of the joint mechanism JEp2, a ball screw may be used that includes a plurality of balls interposed between the thread JEp21 and the nut JEp22.

In addition, for example, a portion of the motor MOr3 may be disposed within the link LK1, and the remaining portion of the motor MOr3 may protrude from the opening Hlk1 to the outside of the link LK1, and the entire joint mechanism JEr3 may be disposed within the link LK2. In addition, for example, the joint mechanism JEr3 may include a storage that accommodates the motor MOr3. In other words, the motor MOr3 may be provided in the joint mechanism JEr3. Alternatively, the motor MOr3 may be considered to be an element of the joint mechanism JEr3. Similarly, the motor MOp1 may be considered to be an element of the joint mechanism JEp1, and the motor MOp2 may be considered to be an element of the joint mechanism JEp2.

Next, the joint mechanisms JEr1, JEr2, JEr4, JEr5, and JEr6 will be briefly described.

The joint mechanism JEr1 includes a rotor JEr11 and a housing JEr12 that accommodates the rotor JEr11, for example. With rotation of a motor MOr1 for driving the joint mechanism JEr1, the rotor JEr11 is rotated around the rotation axis that is the axis Ax1. For example, the rotor JEr11 is attached to the motor MOr1 so as to be rotatable relative to the base part BDPba around the rotation axis that is the axis Ax1. In addition, the housing JEr12, together with the rotor JEr11, is rotated relative to the base part BDPba around the rotation axis that is the axis Ax1. For example, the housing JEr12 is connected to the base part BDPba so as to be rotatable relative to the base part BDPba around the rotation axis that is the axis Ax1. The housing JEr12 is further connected to the joint mechanism JEr2. In this way, with rotation of the rotor JEr11, the joint mechanism JEr2 is rotated relative to the base part BDPba around the rotation axis that is the axis Ax1.

It should be noted that the motor MOr1 may be considered to be an element of the joint mechanism JEr1. In addition, the housing JEr12 may be fixed to the base part BDPba, and the joint mechanism JEr2 may be attached to the rotor JEr11 so as to be rotatable relative to the housing JEr12 around the rotation axis that is the axis Ax1. In this case, the housing JEr12 may be considered to be an element of the base part BDPba.

The joint mechanism JEr2 includes a rotor JEr21 and a housing JEr22 that accommodates a motor MOr2 for driving the joint mechanism JEr2, for example. With rotation of the motor MOr2, the rotor JEr21 is rotated around the rotation axis that is the axis Ax2. For example, the rotor JEr21 is attached to the motor MOr2 so as to be rotatable relative to the housing JEr22 around the rotation axis that is the axis Ax2. The rotor JEr21 is further connected to the link LK1. In addition, the link LK1 is connected to the housing JEr22 so as to be rotatable relative to the housing JEr22. In this way, with rotation of the rotor JEr21, the link LK1 is rotated relative to the housing JEr22 around the rotation axis that is the axis Ax2. In addition, the motor MOr2 is provided within the housing JEr22.

It should be noted that the motor MOr2 may be considered to be an element of the joint mechanism JEr2. In addition, in the example shown in FIG. 2, a portion of the rotor JEr21 is disposed within the link LK1, and the remaining portion of the rotor JEr21 is disposed within the housing JEr22; however, the entire rotor JEr21 may be disposed within the link LK1 or within the housing JEr22.

The joint mechanism JEr4 includes a rotor JEr41 and a housing JEr42 that accommodates the rotor JEr41, for example. With rotation of a motor MOr4 for driving the joint mechanism JEr4, the rotor JEr41 is rotated around the rotation axis that is the axis Ax4. For example, the rotor JEr41 is attached to the motor MOr4 so as to be rotatable relative to the link LK2 around the rotation axis that is the axis Ax4. It should be noted that the motor MOr4 is provided within the link LK2.

In addition, the housing JEr42, together with the rotor JEr41, is rotated relative to the link LK2 around the rotation axis that is the axis Ax4. For example, the housing JEr42 is connected to the link LK2 so as to be rotatable relative to the link LK2 around the rotation axis that is the axis Ax4. The housing JEr42 is further connected to the first portion TP11. In this way, with rotation of the rotor JEr41, the first portion TP11, together with the housing JEr42, is rotated around the rotation axis that is the axis Ax4.

It should be noted that the motor MOr4 may be considered to be an element of the joint mechanism JEr4. In addition, in the example shown in FIG. 2, the entire rotor JEr41 is disposed within the housing JEr42; however, the entire rotor JEr41 may be disposed within the link LK2. Alternatively, a portion of the rotor JEr41 is disposed within the housing JEr42, and the remaining portion of the rotor JEr41 may be disposed within the link LK2.

The joint mechanism JEr5 includes a rotor JEr51 and a housing JEr52 that accommodates a portion of the rotor JEr51, for example. With rotation of a motor MOr5 for driving the joint mechanism JEr5, the rotor JEr51 is rotated around the rotation axis that is the axis Ax5. For example, the rotor JEr51 is attached to the motor MOr5 so as to be rotatable relative to the first portion TP11 around the rotation axis that is the axis Ax5. It should be noted that the motor MOr5 is provided within the housing JEr42 of the joint mechanism JEr4.

In addition, the housing JEr52, together with the rotor JEr51, is rotated relative to the first portion TP11 around the rotation axis that is the axis Ax5. For example, the housing JEr52 is connected to the first portion TP11 so as to be rotatable relative to the first portion TP11 around the rotation axis that is the axis Ax5. The housing JEr52 is further connected to the second portion TP12. In this way, with rotation of the rotor JEr51, the second portion TP12, together with the housing JEr52, is rotated around the rotation axis that is the axis Ax5.

It should be noted that the motor MOr5 may be considered to be an element of the joint mechanism JEr5. In addition, in the example shown in FIG. 2, a portion of the rotor JEr51 is disposed within the housing JEr52, and the remaining portion of the rotor JEr51 is disposed within the first portion TP11; however, the entire rotor JEr51 may be disposed within the housing JEr52 or within the first portion TP11.

The joint mechanism JEr6 includes a rotor JEr61 and a housing JEr62 that accommodates a portion of the rotor JEr61, for example. With rotation of a motor MOr6 for driving the joint mechanism JEr6, the rotor JEr61 is rotated around the rotation axis that is the axis Ax6. For example, the rotor JEr61 is attached to the motor MOr6 so as to be rotatable relative to the second portion TP12 around the rotation axis that is the axis Ax6. In addition, the housing JEr62, together with the rotor JEr61, is rotated relative to the second portion TP12 around the rotation axis that is the axis Ax6. For example, the housing JEr62 is connected to the second portion TP12 so as to be rotatable relative to the second portion TP12 around the rotation axis that is the axis Ax6. In addition, the housing JEr62 includes the end surface TP1sf. For example, with rotation of the rotor JEr61, the end surface TP1sf is rotated relative to the second portion TP12 around the rotation axis that is the axis Ax6.

It should be noted that the motor MOr6 may be considered to be an element of the joint mechanism JEr6. In addition, the housing JEr62 may be fixed to the second portion TP12, and the end effector 20 may be attached to a front surface of the rotor JEr61 so as to be rotatable relative to the housing JEr62. In this case, the front surface of the rotor JEr61 corresponds to the end surface TP1sf. In addition, in a case in which the housing JEr62 is fixed to the second portion TP12, the housing JEr62 may be considered to be an element of the second portion TP12.

In addition, the joint mechanisms JEr are not limited to the examples shown in FIG. 2. For example, each of the plurality of joint mechanisms JEr may have substantially the same configuration as a mechanism for a corresponding joint of a known articulated robot.

In addition, a state (a posture) of the robot 10 shown in FIG. 2 is one of the standing states in which the directions De1 and De2 are parallel to the axis Ax1, and is one of the states representative of features of the robot 10 according to the present embodiment. In the following, the state of the robot 10 shown in FIG. 2 may be referred to as a first state.

For example, the first state is a state in which the directions De1 and De2 are parallel to the axis Ax1, and the end LK2ed1 of the link LK2 is disposed closer to the end LK1ed1 than to the end LK1ed2 of the link LK1. In the first state, preferably, the joint mechanism JEr3 is disposed in an intermediate area ARmd1, in which both ends of the movement area ARmv1 are excluded from the movement area ARmv1, and disposed in an intermediate area ARmd2, in which both ends of the movement area ARmv2 are excluded from the movement area ARmv2. For example, when the robot 10 is on standby in the first state shown in FIG. 2, a maximum amount of movement of a position of the joint mechanism JEr3 relative to the link LK1 is approximately half of a length of the movement area ARmv1 along the direction De1. In addition, a maximum amount of movement of a position of the joint mechanism JEr3 relative to the link LK2 is approximately half of a length of the movement area ARmv2 along the direction De2. Thus, in the present embodiment, by causing the robot 10 to be on standby in the first state shown in FIG. 2, it is possible to substantially prevent prolongation of time required for a state transition in which a state of the robot 10 is changed from the first state to another state.

In addition, in the present embodiment, by setting the links LK1 and LK2 to being in the first state, it is possible to reduce the bulk of the robot 10 and to easily carry the robot 10. Thus, in the present embodiment, it is possible to facilitate installation work, by which the robot 10 is installed in a factory, or work of changing installation of the robot 10 caused by replacing devices in the factory, etc.

In addition, in the standing state such as the first state shown in FIG. 2, postures of the links LK1 and LK2 are maintained such that the links LK1 and LK2 extend along the axis Ax1, as described above. In this case, compared to a case in which the postures of the links LK1 and LK2 are postures in which one of, or each of, the links LK1 and LK2 extends along a direction intersecting the axis Ax1, it is possible to reduce inertial force in a case in which the robot 10 is rotated around the rotation axis that is the axis Ax1.

Thus, in the present embodiment, by setting the links LK1 and LK2 to being in the standing state, it is possible to reduce inertial force caused by a physical length and weight of robotic arms (the links LK1 and LK2). In this way, in the present embodiment, it is possible to precisely control the robot 10. For example, in the present embodiment, it is possible to reduce effects of vibrations (vibration-damping properties) due to a stop of an operation of the robot 10. Thus, in the present embodiment, it is possible to realize reduction in a total operation time of the robot 10 in a case in which the robot 10 performs a predetermined task, and to realize improvement in operation accuracy, etc.

It should be noted that the states of the links LK1 and LK2, which cause reduction in inertial force in a case in which the robot 10 is rotated around the rotation axis that is the axis Ax1, are not limited to the first state shown in FIG. 2, as long as the links LK1 and LK2 are in a posture (the standing state) in a manner that extends along the axis Ax1. For example, another standing state differing from the first state shown in FIG. 2 may be a state in which the directions De1 and De2 are parallel to the axis Ax1, and the end LK2ed1 of the link LK2 is disposed closer to the end LK1ed2 than to the end LK1ed1 of the link LK1. In this case, the link LK2 is disposed such that the links LK1 and LK2 extend along the axis Ax1, and the end section TP1 is far from the link LK1. In other words, in the present embodiment, by setting the state of the robot 10 to the standing state, it is possible to reduce inertial force in a case in which the robot 10 is rotated around the rotation axis that is the axis Ax1. However, the robot 10 is more stable in a state in which the end section TP1 is close to the link LK1 than in a state in which the end section TP1 is far from the link LK1.

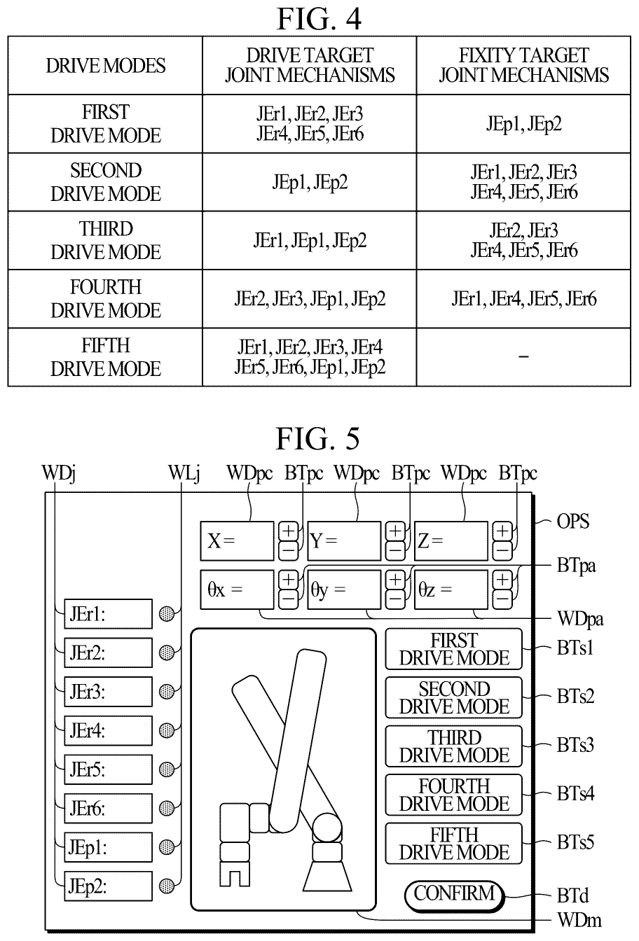

Here, in the present embodiment, the robot controller 30 causes the robot 10 to conduct an operation of each of a cartesian robot, a selective compliance articulated robot arm, and a vertical articulated robot, for example. For example, the robot 10 includes a plurality of drive modes including a drive mode corresponding to an operation of each of a cartesian robot, a selective compliance articulated robot arm, and a vertical articulated robot. The drive mode will be described with reference to FIG. 4 described below.

Next, a hardware configuration of the robot controller 30 will be described with reference to FIG. 3.

FIG. 3 is a diagram showing an example of the hardware configuration of the robot controller 30 shown in FIG. 1.

The robot controller 30 includes a processor 32 for controlling each part of the robot controller 30, a memory 35 storing various types of information, a communication device 36, an operation device 37 for receiving operations by a human operator, etc., a display 38, and a driver circuit 39. It should be noted that the robot controller 30 may be implemented by a single device or may be implemented by a plurality of separate devices. For example, one of, or each of, the operation device 37 and the display 38 may be a separate device from the processor 32.

The memory 35 includes one of, or each of, a volatile memory, such as a random access memory (RAM) that functions as a working area of the processor 32, and a nonvolatile memory, such as an electrically erasable programmable read only memory (EEPROM) that stores various types of information, such as a control program PGr, for example. It should be noted that the memory 35 may be attachable to, and detachable from, the robot controller 30. Specifically, the memory 35 may be a storage medium such as a memory card to be attached to, and to be detached from, the robot controller 30. In addition, the memory 35 may be, for example, a storage device (for example, an online storage) connected to, and communicable with, the robot controller 30 via a network, etc.

The memory 35 shown in FIG. 3 stores the control program PGr. In this embodiment, the control program PGr includes, for example, an application program for the robot controller 30 to control an operation of the robot 10. However, the control program PGr may include, for example, an operating robot system program for the processor 32 to control each part of the robot controller 30.

The processor 32 is a processor for controlling the entire robot controller 30 and is configured to include one or more central processing units (CPUs), for example. The processor 32 functions as an operation controller 33 and a display controller 34 described below by executing the control program PGr stored in the memory 35 to operate in accordance with the control program PGr, for example. It should be noted that the control program PGr may be transmitted from another device via a network, etc.

In addition, for example, in a case in which the processor 32 is configured to include a plurality of CPUs, some or all of functions of the processor 32 may be implemented by the plurality of CPUs operating cooperatively in accordance with a program such as the control program PGr. In addition, the processor 32 may be configured to include hardware such as a graphics processing unit (GPU), a digital signal processor (DSP), or a field programmable gate array (FPGA) in addition to the one or more CPUs or in place of some or all of the one or more CPUs. In this case, some or all of the functions of the processor 32 may be implemented by the hardware such as the DSP. The processor 32 may be considered to be a “computer device.”

The operation controller 33 repeats processing to calculate a joint value relating to a state (a state of a joint) of each of the plurality of joint mechanisms JE until a position and a posture of the robot 10 become a target position and a target posture, for example. A state of a joint mechanism JE may be a state of movement of a joint. Specifically, the state of the joint mechanism JE may be, for example, a position of the joint mechanism JE (a position of the joint) and a rotation angle of rotation caused by a joint mechanism JEr (a direction of the joint), etc. In this case, the joint value indicates the position of the joint mechanism JE (the position of the joint) and the rotation angle of rotation caused by the joint mechanism JEr (the direction of the joint), etc., for example. In the following, the joint value relating to the state of the joint mechanism JE (the state of the joint) may be simply referred to as a joint value for the joint mechanism JE (the joint).

In addition, the operation controller 33 drives, based on joint values for the respective joint mechanisms JE, etc., the robot 10 via the driver circuit 39 described below. In addition, the display controller 34 causes the display 38 to display various types of images such as an operation screen OPS shown in FIG. 5 described below, for example.

The communication device 36 is hardware for communicating with an external device that is present outside the robot controller 30. For example, the communication device 36 has a function of communicating with the external device by Near-field communication. It should be noted that the communication device 36 may further have a function of communicating with the external device via a mobile communication network or a network.

The operation device 37 is an input device (for example, a keyboard, a mouse, a switch, a button, a sensor, etc.) for receiving input from the outside. For example, the operation device 37 receives an operation from a human operator and provides operation information corresponding to the operation to the processor 32. It should be noted that, for example, a touch panel for detecting contact with a display surface of the display 38 may be used as the operation device 37.

The display 38 is an output device such as a display for executing output for the outside. The display 38 displays images under control of the processor 32 (more particularly, the display controller 34), for example. It should be noted that the operation device 37 and the display 38 may be in a single body (for example, a touch panel).

The driver circuit 39 is hardware for providing the robot 10 with signals for driving the robot 10 under control of the processor 32 (more particularly, the operation controller 33). For example, the driver circuit 39 provides, as signals for driving the motors MOr1, MOr2, MOr3, MOr4, MOr5, MOr6, MOp1, and MOp2, etc., signals that are based on the joint values for the respective joint mechanisms JE, to the robot 10.

Thus, the robot controller 30 controls the operation of the robot 10 by controlling the plurality of motors MO (MOr1, MOr2, MOr3, MOr4, MOr5, MOr6, MOp1, and MOp2).

It should be noted that a configuration of the robot controller 30 is not limited to an example shown in FIG. 3. For example, the communication device 36 may be removed from the robot controller 30.

Next, an outline of a method for calculating the joint values for the respective joint mechanisms JE (a method for calculating the joint values by the operation controller 33) will be described, the joint values being used in a case in which the operation of the robot 10 is controlled. The operation of the robot 10 is controlled, for example, by use of a forward kinematics for determining a position and a posture of the robot 10 from displacements (for example, rotation and linear movement, etc.) of joints, or by use of an inverse kinematics for determining displacements of joints from a position and a posture of the robot 10, etc. For example, a relationship between a velocity (hereinafter referred to as a fingertip velocity) of a fingertip of the robot 10 (for example, a distal end of the end effector 20) and a joint velocity is represented by Equation (1). For example, Equation (1) is used for calculation of the forward kinematics.

$$\begin{matrix}[ Formula 1 ] & \\ \dot{r} = J \dot{θ} & ( 1 )\end{matrix}$$

\dot{r}: fingertip velocity (fingertip velocity vector). In the following. It may be referred to as r(⋅).
\dot{θ}: joint velocity (joint velocity vector). In the following, it may be referred to as θ(⋅).
J: Jacobian matrix indicating a relationship between fingertip velocity and joint velocity

It should be noted that the fingertip velocity r(⋅) is represented by Equation (2). In addition, in an articulated robot with m (m is a natural number of two or more) joints, the joint velocity θ(⋅) is represented by Equation (3), and the Jacobian matrix J is represented by Equation (4).

$$\begin{matrix}[ Formula 2 ] & \\ \dot{r} = [ \begin{matrix}\dot{p} \\ ω\end{matrix} ] & ( 2 )\end{matrix}$$

\dot{p}: translational velocity vector of fingertip. In the following, it may be referred to as p(⋅).
ω: angular velocity vector of fingertip.

$$\begin{matrix}[ Formula 3 ] & \\ \dot{θ} = [ \begin{matrix}{\dot{θ}}_{1} \\ ⋮ \\ {\dot{θ}}_{i} \\ ⋮ \\ {\dot{θ}}_{m}\end{matrix} ] & ( 3 )\end{matrix}$$

\dot{θ}ᵢ: joint velocity of i-th joint.

$$\begin{matrix}[ Formula 4 ] & \\ J = [ \begin{matrix}{J}_{1} & … & {J}_{i} & … & {J}_{m}\end{matrix} ] & ( 4 )\end{matrix}$$

Jᵢ: element according to i-th joint.

The Jacobian matrix J is represented by a six-by-m matrix, and elements of an i-th column correspond to elements Ji relating to an i-th joint, for example. The elements Ji relating to the i-th joint are represented by Equation (5) in a case in which the i-th joint is a rotary joint, and are represented by Equation (6) in a case in which the i-th joint is a prismatic joint. It should be noted that zero in Equation (6) indicates that the vector value is zero, for example.

$$\begin{matrix}[ Formula 5 ] & \\ {J}_{i} = [ \begin{matrix}{}_{}^{0} {z}_{i}^{} \times {}_{}^{0} {p}_{ei}^{} \\ {}_{}^{0} {z}_{i}^{}\end{matrix} ] & ( 5 )\end{matrix}$$

$${J}_{i} = [ \begin{matrix}{}_{}^{0} {z}_{i}^{} \\ 0\end{matrix} ] \qquad ( 6 )$$

⁰zᵢ: unit vector in plus Zi axis direction of i-th joint viewed in reference coordinate system Σ0.
⁰pₑᵢ: vector from position of i-th joint viewed in reference coordinate system Σ0 to position of tip of robot.

It should be noted that, although not shown in FIG. 1, a three-axis Cartesian coordinate system, which has an origin at a predetermined position of a respective joint, is in association with the respective joint (a respective joint mechanism JE), and is used to represent a state of the joint. For example, in a case in which the i-th joint is a rotary joint, a rotation axis of a corresponding joint mechanism JEr corresponds to the Z-axis, and in a case in which the i-th joint is a prismatic joint, an axis along a direction of movement of a corresponding joint mechanism JEp or an axis along an direction of expansion or contraction of a corresponding link LK corresponds to the Z-axis.

In addition, in the present embodiment, it is assumed that in a case in which a count is conducted from the body BDP in the order of rotary joints and prismatic joints, the i-th joint mechanism JE corresponds to the i-th joint. For example, the joint mechanism JEr1 corresponds to a first joint, and the joint mechanism JEr2 corresponds to a second joint. The joint mechanism JEr3 corresponds to a third joint, and the joint mechanism JEr4 corresponds to a fourth joint. The joint mechanism JEr5 corresponds to a fifth joint, and the joint mechanism JEr6 corresponds to a sixth joint. In addition, the joint mechanism JEp1 corresponds to a seventh joint, and the joint mechanism JEp2 corresponds to an eighth joint. It should be noted that a numbering method is not limited to the above-described example.

In addition, a relationship between the fingertip velocity of the robot 10 and the joint velocity of the robot 10 is represented by Equation (7) by use of a pseudo-inverse matrix J⁺ of the Jacobian matrix J. For example, Equation (7) is used for calculation of the inverse kinematics.

$$\begin{matrix}[ Formula 6 ] & \\ \dot{θ} = {J}^{+} \dot{r} & ( 7 )\end{matrix}$$

For example, the robot controller 30 uses Equation (7) to calculate joint velocities θi(⋅) of the respective joint mechanisms JE corresponding to a target fingertip velocity r(⋅) and operates the respective joint mechanisms JE based on calculation results. Specifically, the robot controller 30 calculates the joint values for the respective joint mechanisms JE based on the joint velocities θi(⋅) of the respective joint mechanisms JE calculated by use of Equation (7), for example. In addition, the robot controller 30 operates the respective joint mechanisms JE based on the joint values for the respective joint mechanisms JE. For example, the robot controller 30 operates the respective joint mechanisms JE such that the states of the respective joint mechanisms JE become states that are based on the joint values for the respective joint mechanisms JE.

In this way, in the present embodiment, it is possible to cause the robot 10 to conduct an jog operation, for example. It should be noted that the jog operation is an operation by which the joints and the fingertip of the robot 10, etc., are moved little by little to coincide the position and the posture of the robot 10 with a target position and a target posture, for example. The joint velocities θi(⋅) and information indicative of the states of the joint mechanisms JE calculated based on the joint velocities θi(⋅) correspond to the joint values. The calculation of the joint velocities θ(⋅) of the joint mechanisms JE is an example of an inverse kinematics calculation. In addition, since the pseudo-inverse matrix J⁺ is calculated from the Jacobian matrix J, the calculation of the joint velocities θ(⋅) of the joint mechanisms JE by use of Equation (7) corresponds to execution of the inverse kinematics calculation by use of the Jacobian matrix.

Here, when the jog operation is conducted, the joint velocities θi(⋅) are calculated for all of the plurality of joint mechanisms JE. Thus, in a control method in which the Jacobian matrix J is used without any special measures, when the number of joint mechanisms JE is large, a calculation time required to calculate the joint velocities θi(⋅) of the respective joints for setting the position and the posture of the robot 10 to the target position and the target posture, etc., increases. In this case, a solution to the inverse kinematics calculation (the joint velocities θi(⋅) of the respective joints for setting the position and the posture of the robot to the target position and the target posture, etc.) may not be calculated within a desired time.

It should be noted that in the present embodiment, it is possible to select a drive mode of the robot 10 from among the plurality of drive modes including drive modes in which the number of joints (joint mechanisms JE) to be operated is less than a total number of joints. For example, in a drive mode in which a specific i-th joint is not operated, vector values of elements Ji relating to the specific i-th joint among the plurality of elements of the Jacobian matrix J are fixed to zero. When the vector values of the elements Ji relating to the i-th joint are set to zero, the Jacobian matrix J is Equation (8). In this case, the joint velocities θi(⋅) obtained from the above-described Equation (7) are joint velocity vectors represented by Equation (9).

$$\begin{matrix}[ Formula 7 ] & \\ J = [ \begin{matrix}{J}_{1} & … & {J}_{i - 1} & 0 & {J}_{i + 1} & … & {J}_{m}\end{matrix} ] & ( 8 )\end{matrix}$$

$$\dot{θ} = [ \begin{matrix}{\dot{θ}}_{1} \\ ⋮ \\ {\dot{θ}}_{i - 1} \\ 0 \\ {\dot{θ}}_{i + 1} \\ ⋮ \\ {\dot{θ}}_{m}\end{matrix} ] \qquad ( 9 )$$

As shown in Equation (9), the joint velocity θi(⋅) of the i-th joint is zero. Thus, in the present embodiment, since the vector values of the elements Ji relating to the i-th joint among the plurality of elements of the Jacobian matrix J are fixed to zero, a joint value for the i-th joint is not changed; thus, it is possible to consider the i-th joint among the m joints to be a fixed joint. In other words, in the present embodiment, since the vector values of the elements Ji relating to the i-th joint in the Jacobian matrix J are fixed to zero, it is possible to calculate joint velocities θi(⋅) of (m−1) joints other than the i-th joint. Thus, in the present embodiment, it is possible to select a drive mode, in which the number of joints to be operated is less than the total number of joints, to operate the robot 10. It should be noted that in the present embodiment, although the vector values are fixed to zero, it is not necessarily zero and may be a very small value (substantially zero), as long as a joint value for the i-th joint is substantially not changed without effect on robot control. Here, “substantially zero” includes not only actual zero, but also a very small value that can be considered to be zero. In addition, “substantially not changed” includes not only “strictly not changed”, but also a change that can be considered to be no change (for example, a very small change that causes no effect on robot control).

In addition, in the above-described example, a case is assumed in which the fixed joint not to be operated is the single i-th joint; however, the number of fixed joints not to be operated is not limited to one. In other words, as shown in FIG. 4 described below, the plurality of drive modes may include a drive mode in which the number of fixed joints (fixity target joint mechanisms JE) not to be operated is two or more. In the present embodiment, a drive mode of the robot 10 is appropriately selected from among the plurality of drive modes; thus, it is possible to substantially prevent a solution to the inverse kinematics calculation from not being calculated within a desired time.

Next, outlines of the drive modes of the robot 10 will be described with reference to FIG. 4.

FIG. 4 is an explanatory diagram explaining examples of the drive modes of the robot 10. In the present embodiment, a case is assumed in which the robot 10 includes a first drive mode, a second drive mode, a third drive mode, a fourth drive mode, and a fifth drive mode, as the plurality of drive modes.

At least one joint mechanism JE of the plurality of joint mechanisms JE is associated, as a drive target joint mechanism JE, with each of the plurality of drive modes. In the following, a joint mechanism JE other than the drive target joint mechanism JE among the plurality of joint mechanisms JE may be referred to a fixity target joint mechanism JE. The fixity target joint mechanism JE is a joint mechanism JE for which a joint value is not changed in the processing to calculate the joint value for each of the plurality of joint mechanisms JE. For example, in each of the plurality of drive modes, the robot controller 30 controls the operation of the robot 10 by driving drive target joint mechanisms JE in a state in which fixity target joint mechanisms JE among the plurality of joint mechanisms JE are fixed. It should be noted that the drive target joint mechanism JE is an example of a “drive target joint,” and the fixity target joint mechanism JE is an example of a “fixity target joint.” In addition, for example, causing a joint value to be substantially unchanged means substantially maintaining the joint value, and causing a joint value to be unchanged means maintaining the joint value.

In the first drive mode, among the plurality of joint mechanisms JE, the joint mechanisms JEr1, JEr2, JEr3, JEr4, JEr5, and JEr6 are drive target joint mechanisms JE, and the joint mechanisms JEp1 and JEp2 are fixity target joint mechanisms JE. In other words, in the first drive mode, the robot 10 operates as a so-called vertical six-axis articulated robot. In the following, the first drive mode may be referred to as a vertical six-axis articulated mode.

In the second drive mode, among the plurality of joint mechanisms JE, the joint mechanisms JEp1 and JEp2 are drive target joint mechanisms JE, and the joint mechanisms JEr1, JEr2, JEr3, JEr4, JEr5, and JEr6 are fixity target joint mechanisms JE. In other words, in the second drive mode, the robot 10 operates as a so-called cartesian robot. In the following, the second drive mode may be referred to as a cartesian mode.

In the third drive mode, among the plurality of joint mechanisms JE, the joint mechanisms JEr1, JEp1, and JEp2 are drive target joint mechanisms JE, and the joint mechanisms JEr2, JEr3, JEr4, JEr5, and JEr6 are fixity target joint mechanisms JE. In other words, in the third drive mode, the robot 10 operates as a so-called selective compliance articulated robot arm (SCARA robot). In the following, the third drive mode may be referred to as a SCARA mode.

In the fourth drive mode, among the plurality of joint mechanisms JE, the joint mechanisms JEr2, JEr3, JEp1, and JEp2 are drive target joint mechanisms JE, and the joint mechanisms JEr1, JEr4, JEr5, and JEr6 are fixity target joint mechanisms JE. In other words, in the fourth drive mode, in addition to the drive target joint mechanisms JE (JEp1 and JEp2) in the second drive mode (the cartesian mode), the joint mechanisms JEr2 and JEr3 are associated as drive target joint mechanisms JE. In the following, the fourth drive mode may be referred to as an extended cartesian mode. In addition, in the following, the robot in which only four joint mechanisms JEr2, JEr3, JEp1, and JEp2 among the eight joint mechanisms JE are driven may be referred to as an extended cartesian robot.

In the fifth drive mode, each of the plurality of joint mechanisms JE is a drive target joint mechanism JE. In other words, in the fifth drive mode, the plurality of joint mechanisms JE includes no fixity target joint mechanism JE. In the following, the fifth drive mode may be referred to as a standard mode.

In the following, a case is assumed in which the plurality of drive modes are the first drive mode, the second drive mode, the third drive mode, the fourth drive mode, and the fifth drive mode shown in FIG. 4. However, the plurality of drive modes is not limited to an example shown in FIG. 4. For example, the plurality of drive modes may include a drive mode with which the joint mechanisms JEr6 and JEp2 among the plurality of joint mechanisms JE are associated as drive target joint mechanisms JE.

Next, an outline of the operation screen OPS displayed on the display 38 will be described with reference to FIG. 5.

FIG. 5 is an explanatory diagram explaining an example of the operation screen OPS.

For example, the display controller 34 of the robot controller 30 displays, on the display 38, the operation screen OPS for selecting a drive mode from among the plurality of drive modes. Specifically, the display controller 34 provides the display 38 with display information for displaying the operation screen OPS on the display 38, for example. Thus, the operation screen OPS is displayed on the display 38. Generation of the display information by the display controller 34 may be executed in response to an operation for displaying the operation screen OPS being made for the robot controller 30, or may be executed in response to the robot controller 30 being activated, for example.

The operation screen OPS includes a plurality of display windows WD (WDm, WDj, WDpc, and WDpa). On the display window WDm, a video of the robot 10 taken by a capturing device such as a camera is displayed as a video representative of a current state of the robot 10, for example. On each of a plurality of display windows WDj, a current joint value for a corresponding one of the plurality of joint mechanisms JE (JEr1, JEr2, JEr3, JEr4, JEr5, JEr6, JEp1, and JEp2) is displayed.

In addition, on the display windows WDp (WDpc and WDpa), information indicative of a current position and a current posture of the fingertip of the robot 10 is displayed. For example, coordinates of the position of the fingertip of the robot 10 (for example, a center of the end surface TP1sf of the end section TP1 to which the end effector 20 is attached) are displayed on the display windows WDpc. In addition, for example, information indicative of the posture of the fingertip of the robot 10 is displayed on the display windows WDpa. The information indicative of the posture of the fingertip of the robot 10 may be Euler angles represented by a set of three angles, or may be three angles of a roll angle, a pitch angle, and a yaw angle, for example.

In addition, on the operation screen OPS, a plurality of buttons BT (BTpc, BTpa, BTs, and BTd for a graphical user interface (GUI), etc., are displayed. The plurality of buttons BT is used to teach an operation to the robot 10, and to control an operation of the robot 10 in an actual operation other than teaching the robot 10, for example.

The buttons BTp (BTpc and BTpa) are, for example, GUIs for receiving input of information for setting target values for the position and the posture of the fingertip of the robot 10. For example, the target position of the fingertip of the robot 10 is set by use of the three buttons BTpc corresponding to the X-axis, the Y-axis, and the Z-axis, and the target posture of the fingertip of the robot 10 is set by use of the three buttons BTpa corresponding to three angles representative of the posture of the fingertip of the robot 10.

More specifically, the position of the fingertip of the robot 10 on the X-axis is set by use of buttons BTpc corresponding to the X-axis. For example, when a “+” button BTpc is pressed among “+” and “−” buttons BTpc corresponding to the X-axis, a value displayed on a display window WDpc corresponding to the X-axis is increased. It should be noted that when the “−” button BTpc is pressed among the “+” and “−” buttons BTpc corresponding to the X-axis, the value displayed on the display window WDpc corresponding to the X-axis is reduced. In addition, when a “+” button BTpa is pressed among “+” and “−” buttons BTpa corresponding to an angle of the three angles representative of the posture of the fingertip of the robot 10, a value displayed on a display window WDpa corresponding to the angle is increased. It should be noted that the “−” button BTpa is pressed among the “+” and “−” buttons BTpa corresponding to the angle, the value displayed on the display window WDpa corresponding to the angle is reduced.

Thus, a human operator can set the target position and the target posture of the fingertip of the robot 10 by pressing the buttons BTp (BTpc and BTpa).

The buttons BTs (BTs1, BTs2, BTs3, BTs4, and BTs5) are GUIs for receiving input of information for selecting the drive mode of the robot 10. For example, when the button BTs1 is pressed, the first drive mode is selected as the drive mode of the robot 10, and when the button BTs2 is pressed, the second drive mode is selected as the drive mode of the robot 10. In addition, for example, when the button BTs3 is pressed, the third drive mode is selected as the drive mode of the robot 10, and when the button BTs4 is pressed, the fourth drive mode is selected as the drive mode of the robot 10. Then, for example, when the button BTs5 is pressed, the fifth drive mode is selected as the drive mode of the robot 10.

Thus, the human operator can select the drive mode of the robot 10 by pressing the buttons BTs (BTs1, BTs2, BTs3, BTs4, and BTs5).

The button BTd is a GUI for determining, to be final information for teaching the robot 10, the target position and the target posture input by the human operator and the drive mode selected by the human operator, etc., for example. For example, when the button BTd is pressed, a position and a posture based on values displayed on the display windows WDp are determined to be the target position and the target posture, and a drive mode corresponding to a button BTs pressed last by the human operator is determined to be the drive mode of the robot 10. It should be noted that the operation screen OPS may include a GUI for starting teaching the robot 10 and a GUI for terminating the teaching the robot 10.

In addition, on the operation screen OPS, a plurality of warning images WLj is displayed that functions as warning lights for causing the human operator to recognize whether the state of the robot 10 is a specific state, for example. The specific state is, for example, a state in which a joint value of a predetermined joint mechanism JE becomes a value in a neighborhood of a limit value that meets a restriction of movement of the joint mechanism JE (for example, a value obtained by adding a predetermined margin to the limit value). In the following, in a case in which the joint value for the joint mechanism JE is the limit value that meets the restriction of movement of the joint mechanism JE, a state of the joint mechanism JE may be referred to as a limit state. In addition, the predetermined margin is, for example, a margin that is set to cause the robot controller 30 to, before the state of the joint mechanism JE reaches the limit state, recognize that the state of the joint mechanism JE is close to the limit state.

Here, the restriction of movement of the joint mechanism JE may be, for example, a range of movement of the joint mechanism JE (a range of movement of the joint mechanism JEr3 by the joint mechanism JEp1, and a range of movement of the joint mechanism JEr3 by the joint mechanism JEp2, etc.). For example, when the joint mechanism JEr3 is moved by the joint mechanism JEp1 relative to the link LK1, the range of movement of the joint mechanism JEr3 is limited to the movement area ARmv1. Thus, when the joint mechanism JEr3 is disposed at an end of the movement area ARmv1, the joint value for the joint mechanism JEp1 is the limit value, and the state of the joint mechanism JEp1 is the limit state.

Alternatively, the restriction of movement of the joint mechanism JE may be a restriction to avoid a singular point, or may include both the restriction to avoid the singular point and the range of movement of the joint mechanism JE. The singular point is, for example, a point at which the posture of the robot 10 is a posture in which the robot 10 cannot be controlled.

In an example shown in FIG. 5, the operation screen OPS includes the plurality of warning images WLj in one-to-one correspondence with the plurality of joint mechanisms JE. For example, when the state of the robot 10 is the specific state that is based on a restriction to avoid a singular point, a warning image WLj corresponding to a joint mechanism JE corresponding to the singular point is displayed in red. Thus, a warning image WLj corresponding to a joint mechanism JE that is in the specific state is displayed in a specific color (for example, red), and warning images WLj corresponding to joint mechanisms JE that are not in the specific state are displayed in a color other than the specific color. It should be noted that the warning images WLj may cause the human operator to recognize the states of the joint mechanisms JE by use of three or more colors such as blue, yellow, and red. For example, the warning images WLj corresponding to the joint mechanisms JE that are not in the specific state may be displayed in blue or in yellow. In this case, a yellow warning image WLj means that a state of a joint mechanism JE corresponding to the warning image WLj is close to the specific state compared to a blue warning image WLj, for example.

Thus, the operation screen OPS includes the plurality of buttons BT that function as GUIs used to teach an operation to the robot 10 and to control an operation of the robot 10 in actual operations other than teaching the robot 10, for example. In addition, the operation screen OPS includes the plurality of display windows WD and the plurality of warning images WLj for monitoring the operation of the robot 10.

It should be noted that an example of the operation screen OPS is not limited to the example shown in FIG. 5. For example, one or both of the display window WDm and the plurality of display windows WDj are not required to be displayed on the operation screen OPS. In addition, for example, the display controller 34 may selectively display a plurality of operation screens on the display 38. In this case, some of the plurality of display windows WD (WDm, WDj, WDpc, and WDpa) may be displayed on an operation screen separate from the operation screen OPS.

In addition, for example, the warning images WLj may cause the human operator to recognize the states of the joint mechanisms JE by blinking patterns in accordance with the states of the joint mechanisms JE, instead of changing color, or in addition to changing color. In addition, for example, by use of colors or blinking patterns of the plurality of display windows WDj instead of the plurality of warning images WLj, the human operator may be caused to recognize whether the state of the robot 10 is the specific state. Alternatively, by warning sounds instead of the plurality of warning images WLj or in addition to the plurality of warning images WLj, the human operator may be caused to recognize whether the state of the robot 10 is the specific state.

In addition, the number of warning images WLj included in the operation screen OPS is not limited to the example shown in FIG. 5. For example, when the human operator is not particularly notified of a joint mechanism JE corresponding to a singular point, the operation screen OPS may include a single warning image WLj for warning the human operator that the posture of the robot 10 is close to the singular point, instead of the six warning images WLj corresponding to the six joint mechanisms JEr. Alternatively, instead of using the six warning images WLj, by changing a color of the entire operation screen OPS or by blinking the entire operation screen OPS, etc., the human operator may be warned that the posture of the robot 10 is close to a singular point.

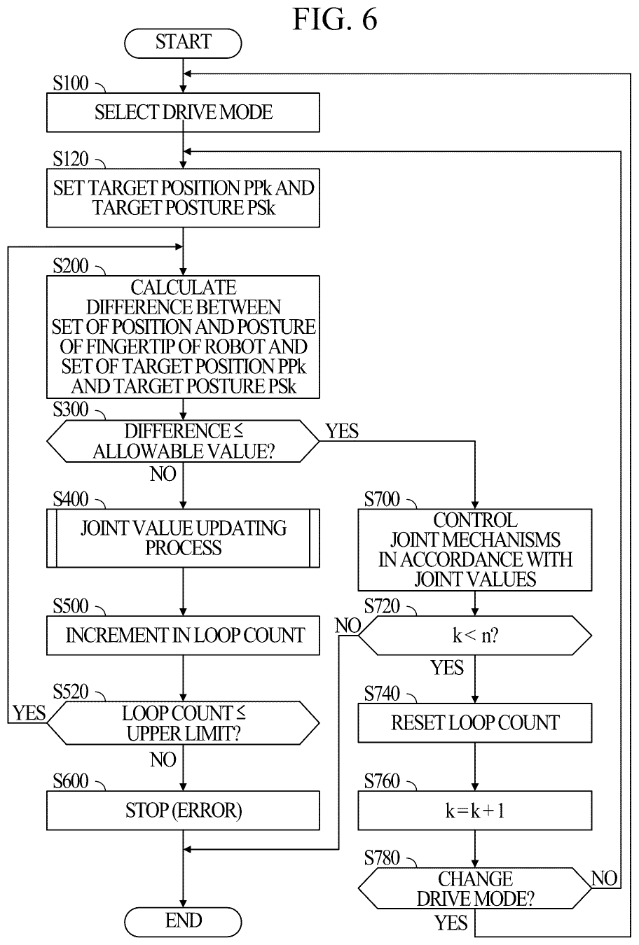

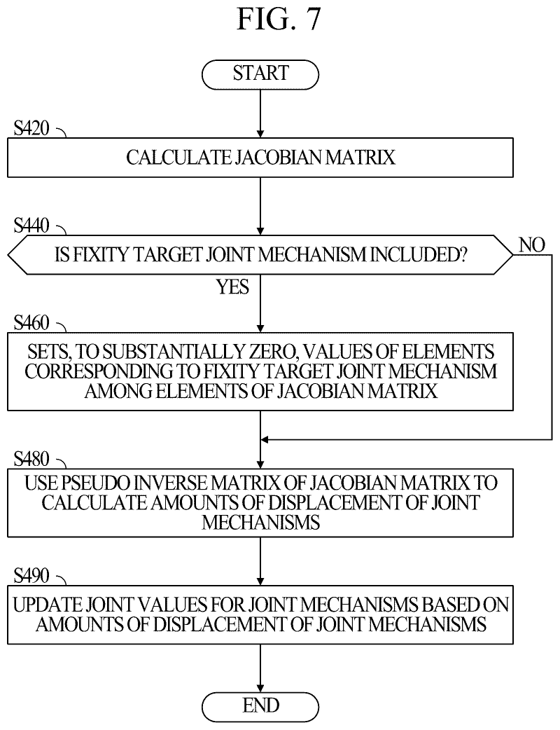

Next, an outline of an operation of the robot controller 30 will be described with reference to FIG. 6 and FIG. 7.

FIG. 6 is a flowchart showing an example of the operation of the robot controller 30 shown in FIG. 1. In the operation shown in FIG. 6, processing is executed to calculate a joint value for each of the plurality of joint mechanisms JE for setting the position and the posture of the fingertip of the robot 10 to a target position PP and a target posture PS (for example, information indicative of positions of the joint mechanisms JE and rotation angles of rotations by the joint mechanisms JEr, etc.). For example, the operation shown in FIG. 6 is executed by the processor 32 that functions as the operation controller 33. In other words, in the operation shown in FIG. 6 (a series of processes from step S100 to step S780), the processor 32 functions as the operation controller 33.

It should be noted that in the operation shown in FIG. 6, a case is assumed in which the number of target positions PP and the number of target postures PS are each n (n is a natural number of one or more). For example, as a movement track of the robot 10 from an initial state to a final target state of the robot 10, n target positions PP and n target postures PS are defined. In the following, the n target positions PP and the n target postures PS may be referred to as n target states. In addition, in the operation shown in FIG. 6, a case is assumed in which an initial value of a variable k (k is a natural number of one or more and n or less) is one. In addition, in the following, a k-th target position PP and a k-th target posture PS may be referred to as a position PPk and a posture PSk, respectively. For example, a position PP1 and a posture PS1 are a first target position PP and a first target posture PS, and a position PPn and a posture PSn are an n-th target position PP and an n-th target posture PS (final targets). The robot controller 30 sequentially updates a target position PPk and a target posture PSk of the fingertip of the robot 10 by changing the variable k from 1 to n in order, for example.

In FIG. 6, the operation of the robot controller 30 is mainly described in a case in which the n target positions PP and the n target postures PS are sequentially set so as to teach the movement track of the robot 10 from the initial state to the final target state of the robot 10.

First, in step S100, the operation controller 33 selects a drive mode of the robot 10. For example, the operation controller 33 selects the drive mode of the robot 10 based on information input via the operation screen OPS shown in FIG. 5. Specifically, the operation controller 33 selects, as the drive mode of the robot 10, a drive mode corresponding to a button BTs pressed prior to a press of the button BTd among the plurality of buttons BTs, for example. It should be noted that when two or more buttons BTs are pressed prior to the press of the button BTd, a drive mode corresponding to a button BTs pressed last prior to the press of the button BTd among the two or more buttons BTs is selected as the drive mode of the robot 10. In addition, for example, when the button BTd is pressed in a case in which any of the plurality of buttons BTs is not pressed after the operation shown in FIG. 6 is started, a predetermined drive mode (for example, the standard mode) is selected as the drive mode of the robot 10.

Next, in step S120, the operation controller 33 sets a k-th target position PPk and a k-th target posture PSk of the fingertip of the robot 10. Specifically, the operation controller 33 sets, as the k-th target position PPk and the k-th target posture PSk of the fingertip of the robot 10, values displayed on the display windows WDp (WDpc and WDpa) at the time of the press of button BTd, for example. After executing the process of step S120, the operation controller 33 advances the process to step S200.

In step S200, the operation controller 33 calculates a difference between a set of the position and the posture of the fingertip of the robot 10 and a set of the target position PPk and the target posture PSk. For example, the operation controller 33 calculates the position and the posture of the fingertip of the robot 10 based on current joint values for the respective joint mechanisms JE. In addition, the operation controller 33 calculates the difference between the set of the position and the posture of the fingertip of the robot 10 calculated based on the current joint values for the respective joint mechanisms JE and the set of the target position PPk and the target posture PSk of the fingertip of the robot 10.

Next, in step S300, the operation controller 33 determines whether the difference between the set of the position and the posture of the fingertip of the robot 10 and the set of the target position PPk and the target posture PSk is less than or equal to an allowable value. The allowable value is, for example, set to a value, which allows the position and the posture of the fingertip of the robot 10 to be considered to be the same as the target position PP and the target posture PS as long as the difference between the set of the position and the posture of the fingertip of the robot 10 and the set of the target position PP and the target posture PS is less than or equal to the allowable value.

When a determination in step S300 is affirmative, the operation controller 33 advances the process to step S700. On the other hand, when the determination in step S300 is negative, the operation controller 33 advances the process to step S400.

In step S400, the operation controller 33 executes a joint value updating process to update joint values of the respective joint mechanisms JE. For example, in the joint value updating process, the operation controller 33 calculates joint values of the respective joint mechanisms JE by executing calculation processing including an inverse kinematics calculation to calculate amounts of displacement of drive target joint mechanisms JE identified from among the plurality of joint mechanisms JE based on the drive mode. It should be noted that details of the joint value updating process will be described with reference to FIG. 7 described below. After executing the joint value updating process in step S400, the operation controller 33 advances the process to step S500.

In step S500, the operation controller 33 adds one to a loop count. It should be noted that the loop count is initialized to zero before the operation shown in FIG. 6 is executed.

Next, in step S520, the operation controller 33 determines whether the loop count is less than or equal to an upper limit. The upper limit is an upper limit of the number of repetitions of a series of processes from step S200 to step S520, and is set to terminate the operation shown in FIG. 6 when the series of processes from step S200 to step S520 is not settled.

When a determination in step S520 is negative, the operation controller 33 stops the operation of the robot 10 as an error in step S600. In this case, the joint values for the respective joint mechanisms JE calculated by the operation shown in FIG. 6 (latest joint values for the respective joint mechanisms JE updated by the joint value updating process in step S400) may not be joint values for setting the position and the posture of the fingertip of the robot 10 to the target position PP and the target posture PS. Thus, the operation controller 33 may notify the human operator, etc., of error information indicating that the process is not settled to calculate joint values for the respective joint mechanisms JE for setting the position and the posture of the fingertip of the robot 10 to the target position PP and the target posture PS. For example, the operation controller 33 may display the error information on the display 38.

On the other hand, the determination in step S520 is affirmative, the operation controller 33 returns the process to step S200. Thus, the series of processes from step S200 to step S520 is repeated until the joint values for the respective joint mechanisms JE for setting the position and the posture of the fingertip of the robot 10 to the target position PP and the target posture PS are calculated, or until the loop count is greater than the upper limit.

In addition, as described above, when the determination in step S300 is affirmative, the process of step S700 is executed. In this case, the joint values (latest joint values) for the respective joint mechanisms JE used to calculate the position and the posture of the fingertip of the robot 10 in step S200 are calculated as the joint values of the respective joint mechanisms JE for setting the position and the posture of the fingertip of the robot 10 to the target position PP and the target posture PS. It should be noted that when the series of processes from step S200 to step S520 is repeated two or more times, the latest joint values used for the process of the step S200 in this time are joint values updated by the joint value updating process in previous step S400.

In step S700, the operation controller 33 controls the respective joint mechanisms JE in accordance with the joint values for the respective joint mechanisms JE updated by the joint value updating process in step S400. As a result, the position and the posture of the fingertip of the robot 10 are changed to the target position PPk and the target posture PSk. It should be noted that when an operation is taught to the robot 10, in step S700, the operation controller 33 stores in the memory 35 the joint values for the respective joint mechanisms JE updated by the joint value updating process in step S400 as joint values for the target position PPk and the target posture PSk. For example, when the operation is taught to the robot 10, the operation controller 33 generates joint state information indicative of the joint values of the plurality of joint mechanisms JE calculated by the joint value updating process and stores the generated joint state information in the memory 35.

Here, for example, when the difference between the set of the position and the posture of the fingertip of the robot 10 in the initial state and the set of the target position PP1 and the target posture PS1 is less than or equal to the allowable value, the joint value updating process in step S400 is not executed even once, and the determination in step S300 is affirmative. In this case, the “joint values for the respective joint mechanisms JE updated by the joint value updating process in step S400” described above is read as “joint values for the respective joint mechanisms JE of the robot 10 in the initial state.” For example, when the joint value updating process in step S400 is not executed even once and the determination in step S300 is affirmative, in step S700, the operation controller 33 maintains the joint values for the respective joint mechanisms JE at the joint values for the respective joint mechanisms JE of the robot 10 in the initial state.

After executing the process of step S700, the operation controller 33 advances the process to step S720.

In step S720, the operation controller 33 determines whether the variable k is less than n. When a determination in step S720 is negative, in other words, when the position and the posture of the fingertip of the robot 10 are changed to the final target position PPn and the final target posture PSn, the operation controller 33 terminates the operation shown in FIG. 6. On the other hand, when the determination in step S720 is affirmative, the operation controller 33 resets the loop count to zero in step S740 and then advances the process to step S760.

In step S760, the operation controller 33 adds one to the variable k (k=k+1). Then, the operation controller 33 advances the process to step S780.

In step S780, the operation controller 33 determines whether to change the drive mode. It should be noted that in step S780, the processor 32 may function as the display controller 34 to display, on the operation screen OPS, a message representing that input of information for setting a next target position PPk and a next target posture PSk can be received. Then, the processor 32 functions as the operation controller 33 to determine whether to change the drive mode in response to a press of the button BTd. For example, the operation controller 33 determines, when the button BTd is pressed in a case in which any of the plurality of buttons BTs is not pressed, that the drive mode is not to be changed, and determines, when any of the plurality of buttons BTs is pressed prior to a press of the button BTd, that the drive mode is to be changed. It should be noted that when any of the plurality of buttons BTs is pressed prior to a press of the button BTd and when a drive mode corresponding to the pressed button BTs is the same as a drive mode that is currently selected, the operation controller 33 may determine that the drive mode is not to be changed.

When a determination in step S780 is affirmative, the operation controller 33 returns the process to step S100. As a result, in step S100, a drive mode corresponding to the next target position PPk and the next target posture PSk of the fingertip of the robot 10 is selected, and in step S120, the next target position PPk and the next target posture PSk of the fingertip of the robot 10 are set. On the other hand, when the determination in step S780 is negative, the operation controller 33 returns the process to step S120. As a result, the drive mode is not changed, and in step S120, the next target position PPk and the next target posture PSk of the fingertip of the robot 10 are set.

Thus, in the operation shown in FIG. 6, for each of the n target states (the positions PP and the postures PS), the series of processes from step S200 to step S520 is repeated until the difference between the set of the position and the posture of the fingertip of the robot 10 and the set of the target position PPk and the target posture PSk is less than or equal to the allowable value.

It should be noted that the operation of the robot controller 30 is not limited to an example shown in FIG. 6. For example, the process of step S780 may be omitted. In this case, after executing the process of step S760, the operation controller 33 returns the process to step S100. In addition, the process of step S100 may be executed after the process of step S120 or may be executed in parallel to the process of step S120.

In addition, in the above-described explanation, a case is assumed in which the information about the n positions PP and the n postures PS, etc., are input while the operation shown in FIG. 6 is executed; however, the operation shown in FIG. 6 may be started after the n target positions PP and the n target postures PS are stored in the memory 35, for example. In this case, the drive mode of the robot 10 is in association with the n target positions PP and the n target postures PS, and is stored in the memory 35, for example. In addition, a series of steps S100 and S120 is executed based on the information (the drive mode, the positions PP, and the postures PS) stored in the memory 35. In addition, in this case, the process of step S780 may be omitted.

Next, the joint value updating process in step S400 will be described with reference to FIG. 7.

FIG. 7 is a flowchart showing an example of the joint value updating process shown in FIG. 6. For example, the processor 32 functions as the operation controller 33 and executes a series of processes from step S420 to step S490 shown in FIG. 7 as the joint value updating process in step S400 shown in FIG. 6. Thus, the process of step S420 is executed when the determination in step S300 shown in FIG. 6 is negative. In addition, after the process of step S490 is executed, the process of step S500 shown in FIG. 6 is executed.

First, in step S420, the operation controller 33 calculates a Jacobian matrix J based on the current joint values for the respective joint mechanisms JE. Then, the operation controller 33 advances the process to step S440.

In step S440, the operation controller 33 determines whether a fixity target joint mechanism JE is included in the plurality of joint mechanisms JE. For example, when the drive mode of the robot 10 is the fifth drive mode, the operation controller 33 determines that no fixity target joint mechanism JE is included in the plurality of joint mechanisms JE. In other words, when the drive mode of the robot 10 is a drive mode other than the fifth drive mode, the operation controller 33 determines that a fixity target joint mechanism JE is included in the plurality of joint mechanisms JE.

When a determination in step S440 is affirmative, the operation controller 33 advances the process to step S460. On the other hand, when the determination in step S440 is negative, the operation controller 33 advances the process to step S480.

In step S460, the operation controller 33 sets, to substantially zero, values of elements corresponding to fixity target joint mechanisms JE among the plurality of elements of the Jacobian matrix J. As a result, for example, the values of the elements of columns corresponding to the fixity target joint mechanisms JE of the Jacobian matrix J are set to substantially zero. Then, the operation controller 33 advances the process to step S480.

In step S480, the operation controller 33 uses a pseudo-inverse matrix J⁺ of the Jacobian matrix J to calculate the amounts of displacement of the respective joint mechanisms JE (for example, joint velocities θi(⋅) of the respective joint mechanisms JE). It should be noted that when a fixity target joint mechanism JE is included in the plurality of joint mechanisms JE, values of elements of a column corresponding to the fixity target joint mechanism JE of the Jacobian matrix J are set to substantially zero; thus, an amount of displacement of the fixity target joint mechanism JE is zero or approximately zero. It should be noted that approximately zero is, for example, a value that can be considered to be zero. After executing the process of step S480, the operation controller 33 advances the process to step S490.

In step S490, the operation controller 33 updates the joint values for the respective joint mechanisms JE based on the amounts of displacement of the respective joint mechanisms JE. For example, the operation controller 33 updates the joint values for the respective joint mechanisms JE by adding the amounts of displacement of the respective joint mechanisms JE to the joint values for the respective joint mechanisms JE used for the calculation of the position and the posture of the fingertip of the robot 10 in step S200 shown in FIG. 6. It should be noted that when a fixity target joint mechanism JE is included in the plurality of joint mechanisms JE, an amount of displacement of the fixity target joint mechanism JE is zero or approximately 0; thus, a joint value of the fixity target joint mechanism JE updated by the process of step S490 is a value that is the same as, or approximately the same as, a value prior to the update. It should be noted that the value that is approximately the same as the value prior to the update is, for example, a value that can be considered to be the same as the value prior to the update. Thus, a state of the fixity target joint mechanism JE is unchanged and is maintained. Thus, in the present embodiment, it is possible to drive only the drive target joint mechanisms JE, which are identified based on the drive mode, among the plurality of joint mechanisms JE.

Here, for example, a series of processes of step S480 and S490 is an example of “calculation processing,” and a series of processes of step S440 and S460 is an example of “fixity processing.” It should be noted that the “calculation processing” may include the process of step S420 in addition to the series of processes of step S480 and S490. Alternatively, a series of processes from step S420 to step S490 may be considered to be the “calculation processing.” In this case, the “calculation processing” includes the “fixity processing.”

It should be noted that the joint value updating process is not limited to the example shown in FIG. 7. For example, the operation controller 33 may determine, in step S440, whether a fixity target joint mechanism JE or a joint mechanism JE in the specific state described in FIG. 5 is included in the plurality of joint mechanisms JE. In this case, as in the fixity target joint mechanism JE, regarding the joint mechanism JE in the specific state, values of elements corresponding to the joint mechanism JE in the specific state among the plurality of elements of the Jacobian matrix J are set to substantially zero in step S460. In this aspect, the joint mechanism JE in the specific state, as well as the fixity target joint mechanism JE, is treated as a fixed joint; thus, it is possible to substantially prevent the state of the joint mechanism JE from being a state in which the restriction of movement of the joint mechanism JE is not met (for example, a state outside a movable range).

In addition, in the robot 10 to which the operation is taught, for example, the respective joint mechanisms JE are operated in accordance with the taught joint values (for example, the joint values indicated by the joint state information stored in the memory 35 in step S700). However, when the robot 10 to which the operation has been taught operates by complementing states between the n target states (the positions PP and the postures PS) used for teaching the robot 10, the robot controller 30 executes operations that are substantially the same as the operations shown in FIG. 6 and FIG. 7. In this case, the drive mode of the robot 10 is in association with the n target positions PP and the n target postures PS and is stored in the memory 35, for example.

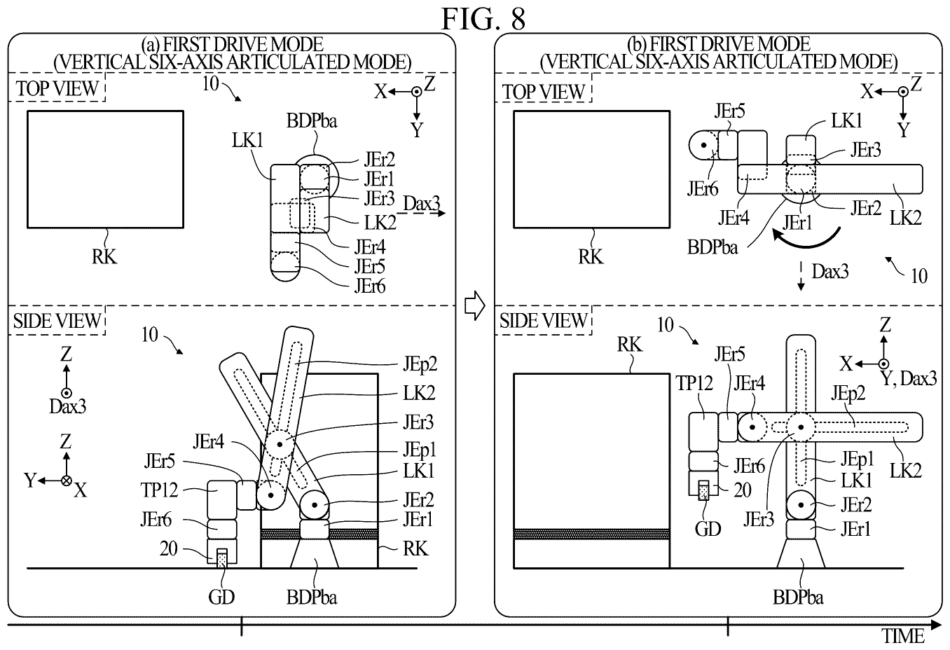

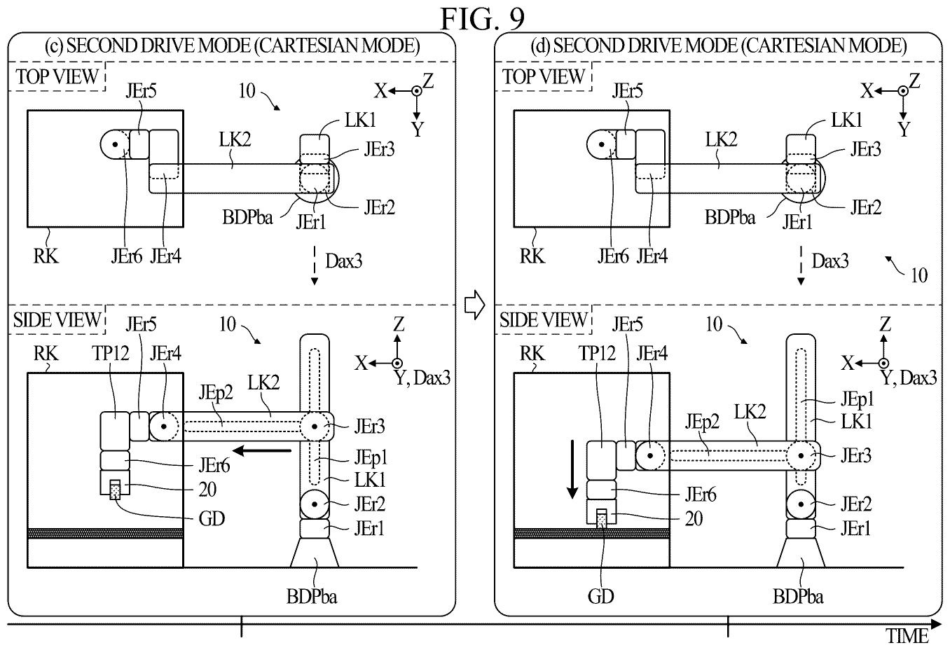

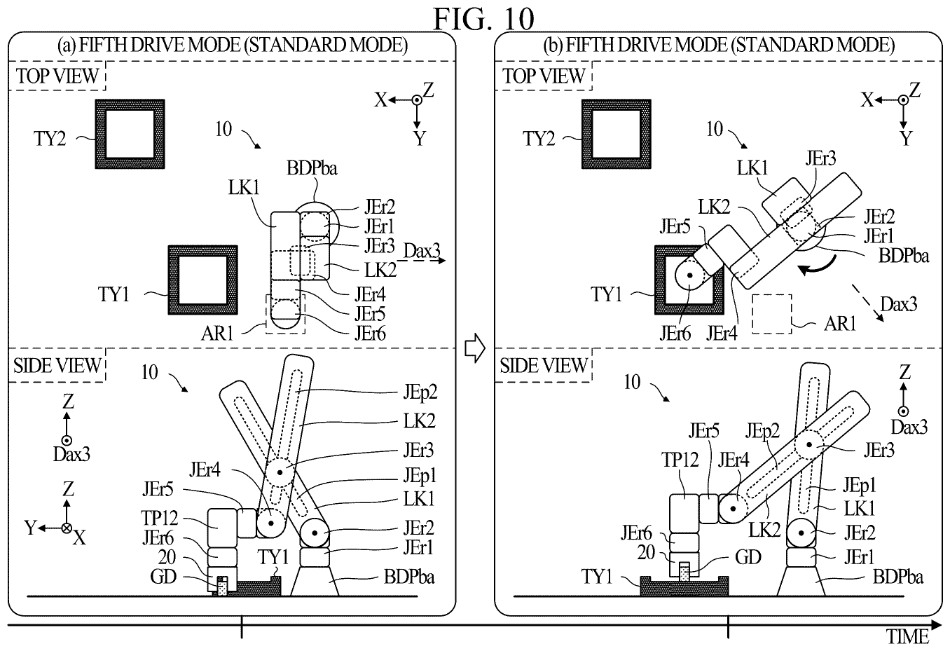

Next, with reference to FIG. 8 and FIG. 9, an example of an operation of the robot system 1 will be described in a case in which the robot 10 is taught an operation to move an object GD from the outside of a shelf RK to the inside of the shelf RK.

FIG. 8 is an explanatory diagram explaining an example of an operation of the robot system 1. FIG. 9 is an explanatory diagram explaining an operation following the operation of the robot system 1 shown in FIG. 8.

FIG. 8 and FIG. 9 show main states of the robot 10 during an operation in which the robot 10 moves the object GD from the outside of the shelf RK (for example, a floor) to the inside of the shelf RK. Top views included in the drawings schematically show the robot 10 as viewed from a point in a +Z direction, and side views included in the drawings schematically show the robot 10 as viewed from a point in a direction Dax3. It should be noted that the +Z direction is a direction indicated by an arrow of the Z-axis, and the direction Dax3 is a direction from the link LK1 toward the link LK2 among directions along the axis Ax3 that is the rotation axis of the joint mechanism JEr3.

In the following, the +Z direction may be referred to as an upward direction, and a direction opposite to the +Z direction may be referred to as a −Z direction or as a downward direction. In addition, in the following, a case may occur in which the +Z direction and the −Z direction need not be particularly distinguished from each other and may be referred to as a Z-axis direction or as a vertical direction. In addition, in the following, a direction indicated by an arrow of the X-axis may be referred to as a +X direction, and a direction opposite to the +X direction may be referred to as a −X direction. In the following, a case may occur in which the +X direction and the −X direction need not be particularly distinguished from each other and may be referred to as an X-axis direction.

For example, as shown in FIG. 8(a) and FIG. 8(b), for an operation of the robot 10 by which the object GD is picked up from the floor and the picked-up object GD is conveyed in front of the shelf RK, there is little restriction of a working area, and the robot 10 is in complicated postures. Thus, for the above-described operation, the standard mode (the fifth drive mode), in which all of the plurality of joint mechanisms JE is a drive target joint mechanism JE, or the vertical six-axis articulated mode (the first drive mode) is appropriate as the drive mode of the robot 10.

In FIG. 8, a case is assumed in which the vertical six-axis articulated mode is selected. In addition, in description from FIG. 8, explanation of an operation of input of the target positions PP and the target postures PS via the operation screen OPS will be omitted. For example, when the teaching the robot 10 is started, the human operator presses the button BTs1 shown in FIG. 5 and then presses the button BTd. As a result, in step S100 shown in FIG. 6, the vertically six-axis articulated mode is selected. In addition, since the vertical six-axis articulated mode is selected, in step S460 shown in FIG. 7, values of elements corresponding to the respective joint mechanisms JEp1 and JRp2 among the plurality of elements of the Jacobian matrix J are set to substantially zero. As a result, the robot 10 operates as the vertical six-axis articulated robot in which only the six joint mechanisms JEr (JEr1, JEr2, JEr3, JEr4, JEr5, and JEr6) are driven among the eight joint mechanisms JE.

As shown in FIG. 9(c) and FIG. 9(d), the object GD having been conveyed in front of the shelf RK (see FIG. 8(b)) is conveyed to the inside of the shelf RK and is disposed at the inside of the shelf RK. It should be noted that in FIG. 8 and FIG. 9, a case is assumed in which the posture of the robot 10 at a point of time at which the robot 10 completes the operation to convey the object GD in front of the shelf RK is a posture (hereinafter referred to as a perpendicular posture) in which the direction De1 is parallel to the axis Ax1 and the direction De2 is perpendicular to the direction De1.

Regarding an operation of the robot 10 by which the object GD having been conveyed in front of the shelf RK is conveyed to the inside of the shelf RK and then the object GD is disposed at the inside of the shelf RK (see FIG. 9(c) and FIG. 9(d)), the shelf RK itself becomes an obstacle to the operation of the robot 10; thus, restrictions of the working area are increased. Thus, when the vertical six-axis articulated mode (the first drive mode) or the standard mode (the fifth drive mode) is selected for the above-described operation, there are numerous restrictions on the operation of the robot 10. Consequently, for the above-described operation, the cartesian mode (the second drive mode) is appropriate as the drive mode of the robot 10.

Thus, for example, after the object GD is conveyed in front of the shelf RK, the human operator presses the button BTs2 shown in FIG. 5 and presses the button BTd after the press of the button BTs2. As a result, in step S780 shown in FIG. 6, it is determined that the drive mode is to be changed, and the cartesian mode is selected in step S100. In addition, since the cartesian mode is selected, in step S460 shown in FIG. 7, values of elements corresponding to the respective six joint mechanisms JEr (JEr1, JEr2, JEr3, JEr4, JEr5, and JEr6) among the plurality of elements of the Jacobian matrix J are set to substantially zero. As a result, the robot 10 operates as the cartesian robot in which only two joint mechanisms JEp (JEp1 and JEp2) among the eight joint mechanisms JE are driven.

In the cartesian mode, for example, the joint mechanisms JEp1 and JEp2 can easily implement movement of the link LK2 in the Z-axis direction (the vertical direction) and movement of the link LK2 in a direction perpendicular to the Z-axis (for example, the X-axis direction), respectively.

For example, as shown in FIG. 9(c), the robot controller 30 moves the link LK2 in the +X direction by driving the joint mechanism JEp2. As a result, the object GD is conveyed to the inside of the shelf RK. In addition, as shown in FIG. 9(d), the robot controller 30 moves the link LK2 in the −Z direction (the downward direction) by driving the joint mechanism JEp1. As a result, the end section TP1 of the robot 10, together with the link LK2, moves in the downward direction; thus, the object GD is conveyed at the inside of the shelf RK. Thus, in the present embodiment, since the robot 10 can operate as the cartesian robot, it is possible to smoothly operate the robot 10 in a state in which the shelf RK does not become an obstacle. In addition, in the present embodiment, by operating the robot 10 as the cartesian robot, it is possible to easily control the robot 10.

It should be noted that when the cartesian mode is selected, the robot controller 30 may determine whether the posture of the robot 10 is the perpendicular posture before the process of step S200 shown in FIG. 6 is executed, for example. Then, when the posture of the robot 10 is not the perpendicular posture, the robot controller 30 may change the posture of the robot 10 to the perpendicular posture to execute the process of step S200 shown in FIG. 6.

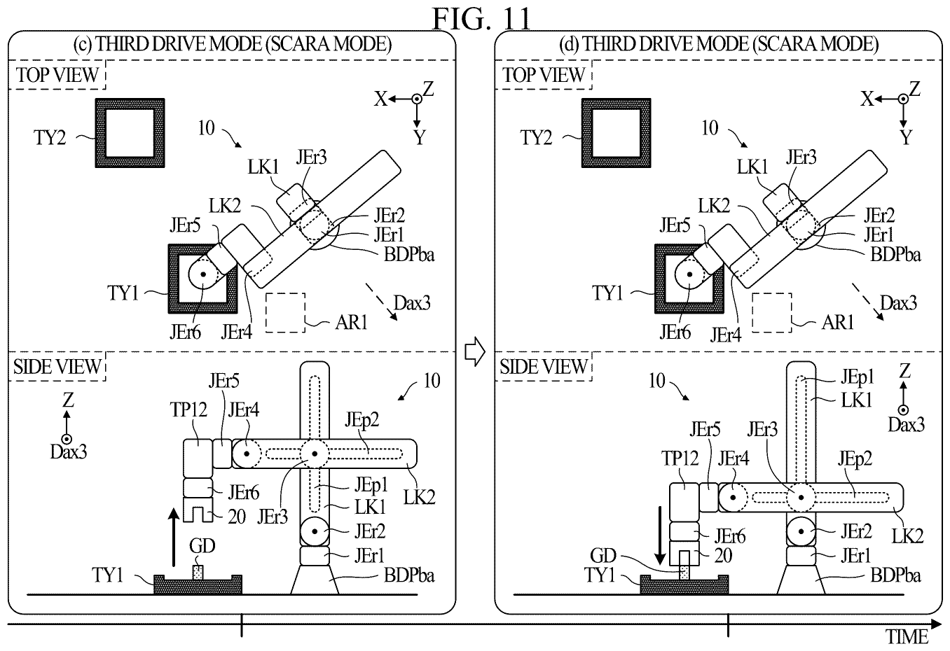

Next, with reference to FIG. 10 to FIG. 13, an example of an operation of the robot system 1 will be described in a case in which the robot 10 is taught an operation to move the object GD from a region AR1 through a tray TY1 to a tray TY2.

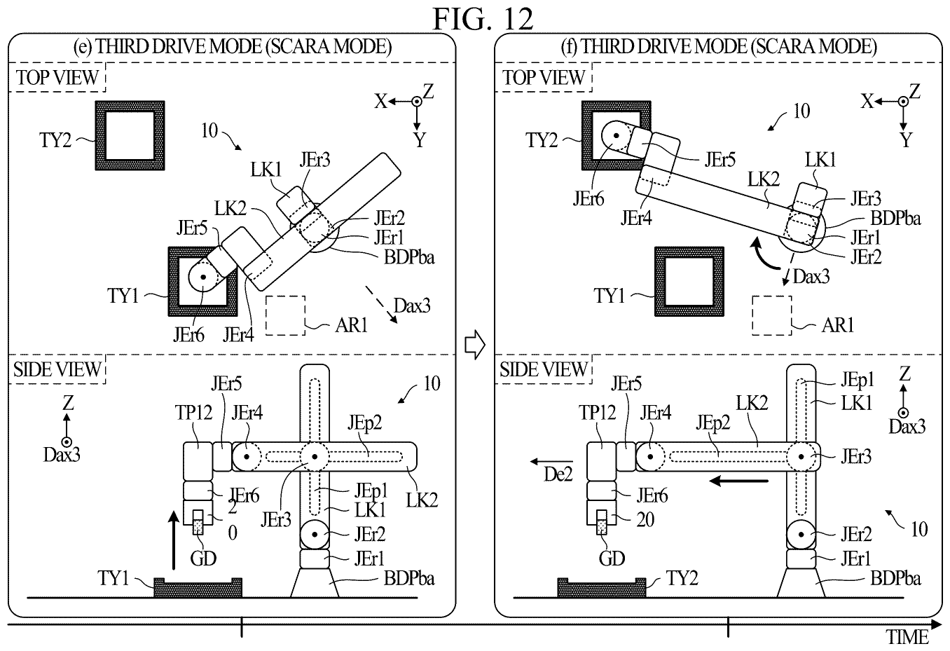

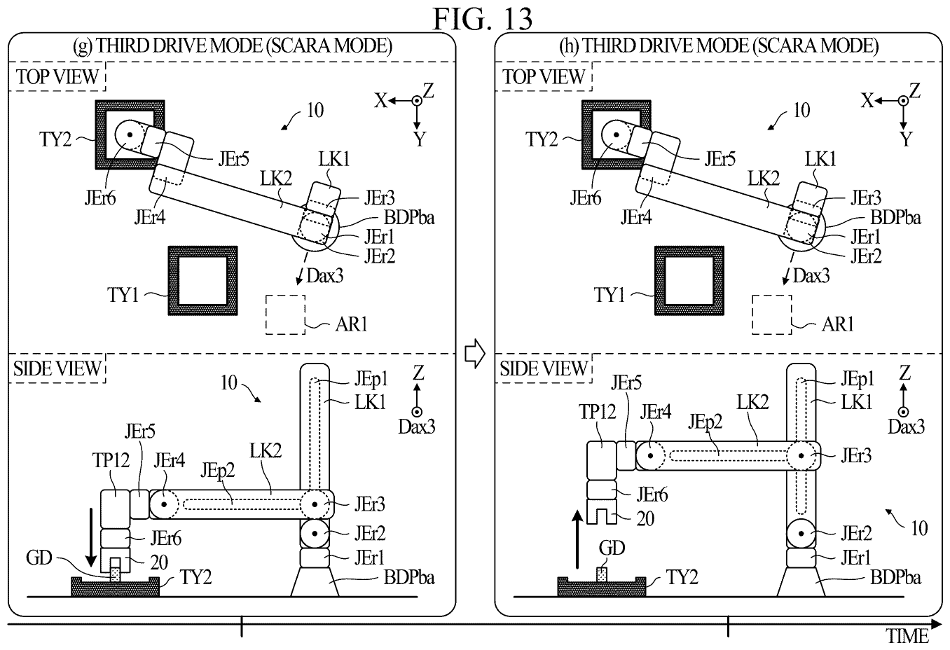

FIG. 10 is an explanatory diagram explaining another example of the operation of the robot system 1. FIG. 11 is an explanatory diagram explaining an operation following the operation of the robot system 1 shown in FIG. 10. FIG. 12 is an explanatory diagram explaining an operation following the operation of the robot system 1 shown in FIG. 11. FIG. 13 is an explanatory diagram explaining an operation following the operation of the robot system 1 shown in FIG. 12.

FIG. 10 to FIG. 13 show main states of the robot 10 during an operation in which the robot 10 moves the object GD from the region AR1 through the tray TY1 to the tray TY2. Top views included in the drawings schematically show the robot 10 as viewed from a point in the +Z direction, and side views included in the drawings schematically show the robot 10 as viewed from a point in the direction Dax3.

For example, as shown in FIG. 10(a) and FIG. 10(b), for an operation of the robot 10 by which the object GD is picked up from the region AR1 and the picked-up object GD is conveyed to the tray TY1 for temporary place, there is little restriction in a working area, and the robot 10 is in complicated postures. Thus, for the above-described operation, the vertical six-axis articulated mode (the first drive mode) or the standard mode (the fifth drive mode) is appropriate as the drive mode of the robot 10.

In FIG. 10, since the region AR1 is an area close to the body BDP, a case is assumed in which the standard mode is selected that is appropriate for performing work on the object GD disposed in the area close to the body BDP. For example, when teaching the robot 10 is started, the human operator presses the button BTs5 shown in FIG. 5 and then presses the button BTd. As a result, in step S100 shown in FIG. 6, the standard mode is selected. In addition, since the standard mode is selected, a determination in step S440 shown in FIG. 7 is negative. As a result, the robot 10 operates as an eight-axis articulated robot in which all of the eight joint mechanisms JE is driven.

After conveying the object GD to the tray TY1, the robot 10 changes the posture above the tray TY1 as shown in FIG. 11(c).

An operation of the robot 10 by which the object GD is moved from the tray TY1 to the tray TY2 is an operation at which a selective compliance articulated robot arm (a SCARA robot) is skillful. Thus, for the above-described operation, the SCARA mode (the third drive mode) is appropriate as the drive mode of the robot 10.

Thus, for example, after the robot 10 operating in the standard mode conveys the object GD to the tray TY1 and then changes the posture to the perpendicular posture above the tray TY1, the human operator presses the button BTs3 shown in FIG. 5. Then, the human operator presses the button BTd after the press of the button BTs3. As a result, in step S780 shown in FIG. 6, it is determined that the drive mode is to be changed, and the SCARA mode is selected in step S100. In addition, since the SCARA mode is selected, in step S460 shown in FIG. 7, values of elements corresponding to the respective joint mechanisms JEr2, JEr3, JEr4, JEr5, and JEr6 among the plurality of elements of the Jacobian matrix J are set to substantially zero. As a result, the robot 10 operates as the selective compliance articulated robot arm (SCARA robot) in which only three joint mechanisms JEr1, JEp1, and JEp2 among the eight joint mechanisms JE are driven.

For example, as shown in FIG. 11(c), the robot controller 30 causes the robot 10 to conduct an operation to convey the object GD to the tray TY1 and then changes the posture of the robot 10 to the perpendicular posture above the tray TY1. Then, the robot controller 30 changes the drive mode of the robot 10 from the standard mode to the SCARA mode.

Next, as shown in FIG. 11(d), the robot controller 30 moves the link LK2 in the −Z direction (the downward direction) by driving the joint mechanism JEp1. As a result, the end section TP1 of the robot 10, together with the link LK2, is moved in the downward direction. Then, as shown in FIG. 12(e), the robot controller 30 causes the robot 10 to pick up the object GD disposed on the tray TY1.

Next, as shown in FIG. 12(e), the robot controller 30 moves the link LK2 in the +Z direction (the upward direction) by driving the joint mechanism JEp1. Then, as shown in FIG. 12 (f), the robot controller 30 moves the end section TP1 of the robot 10 above the tray TY2 by driving the joint mechanisms JEr1 and JEp2. Specifically, the robot controller 30 rotates the entire robot 10 by driving the joint mechanism JEr1, and moves the link LK2 in a direction (the direction De2) in which the end section TP1 departs from the body BDP by driving the joint mechanism JEp2.

Then, as shown in FIG. 13(g), the robot controller 30 moves the link LK2 in the −Z direction (the downward direction) by driving the joint mechanism JEp1. As a result, the end section TP1 of the robot 10, together with the link LK2, is moved in the downward direction; thus, the object GD is conveyed to the tray TY2. Then the object GD is disposed on the tray TY2. After the object GD is disposed on the tray TY2, as shown in FIG. 13(h), the robot controller 30 moves the link LK2 in the +Z direction (the upward direction) by driving the joint mechanism JEp1. As a result, the end section TP1 of the robot 10, together with the link LK2, is moved in the upward direction.

Thus, in the present embodiment, it is possible to freely switch between the standard mode (the fifth drive mode) in which all of the eight joint mechanisms JE is driven and the SCARA mode (the third drive mode) in which only the three joint mechanisms JEr1, JEp1, and JEp2 among the eight joint mechanisms JE are driven. Thus, in the present embodiment, it is possible to substantially prevent control of the robot 10 from being complicated. For example, in a case in which the standard mode or the vertical six-axis articulated mode is selected for the operation of the robot 10 by which the object GD is moved from the tray TY1 to the tray TY2, the number of driven joint mechanisms JE is large compared to a state in which the SCARA mode is selected. In this case, control of the robot 10 is complicated compared to a state in which the SCARA mode is selected.

It should be noted that when the SCARA mode is selected, the robot controller 30 may determine whether the posture of the robot 10 is the perpendicular posture before the process of step S200 shown in FIG. 6 is executed, for example. Then, when the posture of the robot 10 is not the perpendicular posture, the robot controller 30 may change the posture of the robot 10 to the perpendicular posture to execute the process of step S200 shown in FIG. 6.

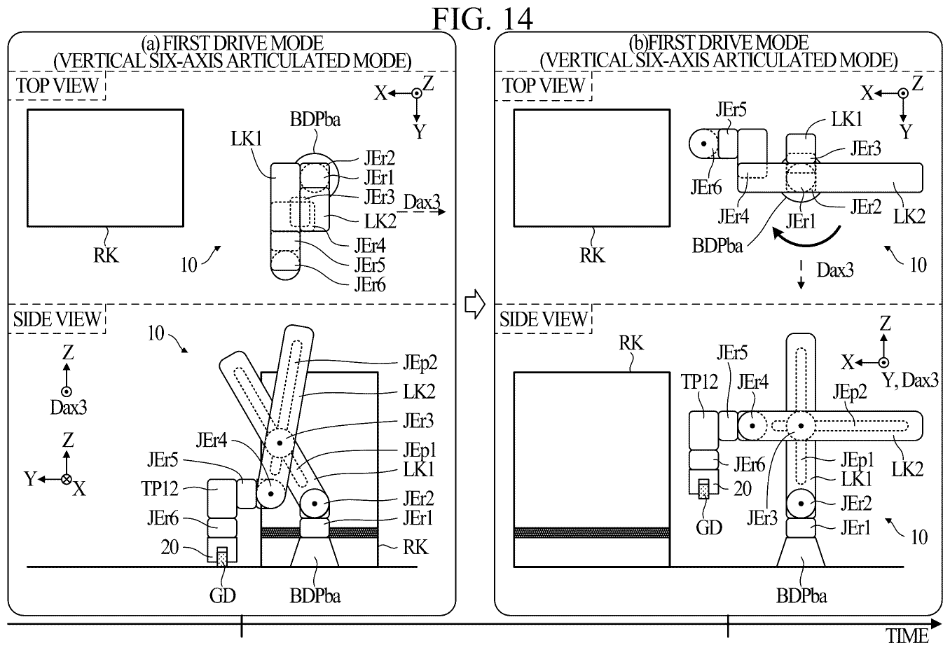

Next, with reference to FIG. 14 to FIG. 16, an example of an operation of the robot system 1 will be described in a case in which the robot 10 is taught an operation to move the object GD from the outside of the shelf RK to the inside of the shelf RK. It should be noted that in the operation shown in FIG. 14 to FIG. 16, the object GD is disposed at the back of the shelf RK compared to the operation shown in FIG. 8 and FIG. 9.

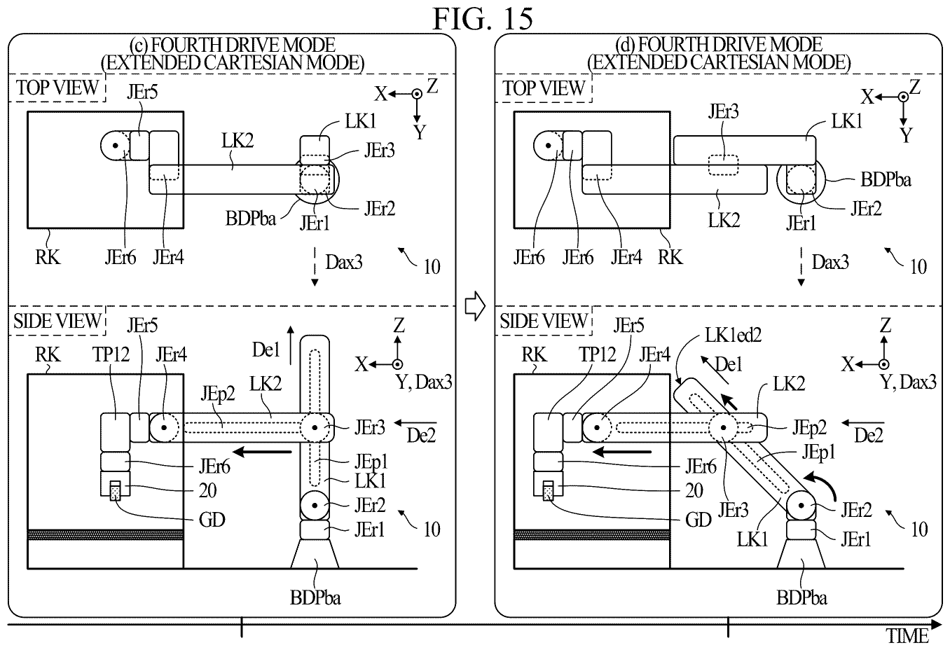

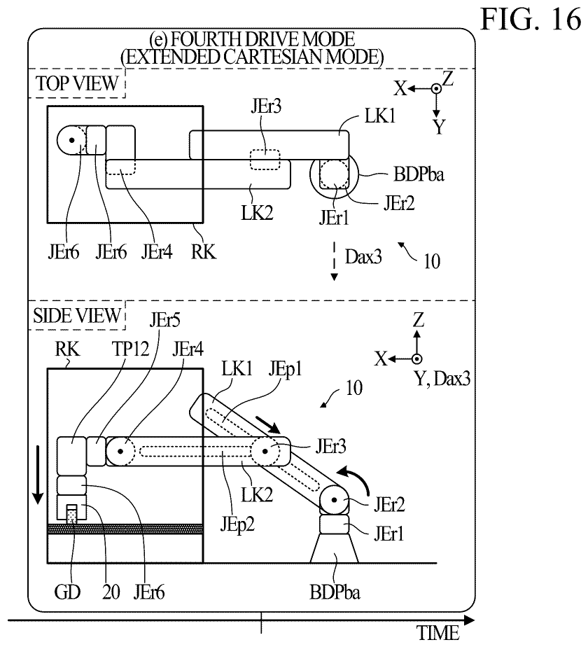

FIG. 14 is an explanatory diagram explaining another example of the operation of the robot system 1. FIG. 15 is an explanatory diagram explaining an operation following the operation of the robot system 1 shown in FIG. 14. FIG. 16 is an explanatory diagram explaining an operation following the operation of the robot system 1 shown in FIG. 15.

FIG. 14 to FIG. 16 show main states of the robot 10 during an operation in which the robot 10 moves the object GD from the outside of the shelf RK (for example, a floor) to the back of the shelf RK. Top views included in the drawings schematically show the robot 10 as viewed from a point in the +Z direction, and side views included in the drawings schematically show the robot 10 as viewed from a point in the direction Dax3.

As shown in FIG. 14(a) and FIG. 14(b), an operation of the robot 10, by which the object GD is picked up from the floor and the picked-up object GD is conveyed in front of the shelf RK, is substantially the same as that described with reference to FIG. 8(a) and FIG. 8(b). Thus, explanation of the operation of the robot 10 by which the object GD is picked up from the floor and the picked-up object GD is conveyed in front of the shelf RK is omitted.

As shown in FIG. 15(c) and FIG. 15(d), the object GD (see FIG. 14(b)) having been conveyed in front of the shelf RK is conveyed to the inside of the shelf RK and then is disposed at the back of the shelf RK. In an operation of the robot 10 by which the object GD having been conveyed in front of the shelf RK is conveyed to the inside of the shelf RK and the object GD is disposed at the back of the shelf RK, the shelf RK itself become an obstacle to the operation of the robot 10; thus, restrictions of a working area are increased, as in the operation shown in FIG. 9. Thus, for the above-described operation, the cartesian mode (the second drive mode) or the extended cartesian mode (the fourth drive mode) is appropriate as the drive mode of the robot 10. In FIG. 15, since the object GD is disposed at the back of the shelf RK, a case is assumed in which the extended cartesian mode is selected.

For example, after the object GD is conveyed in front of the shelf RK, the human operator presses the button BTs4 shown in FIG. 5 and presses the button BTd after the press of the button BTs4. As a result, in step S780 shown in FIG. 6, it is determined that the drive mode is to be changed, and the extended cartesian mode is selected in step S100. In addition, since the extended cartesian mode is selected, in step S460 shown in FIG. 7, values of elements corresponding to the respective four joint mechanisms JEr1, JEr4, JEr5, and JEr6 among the plurality of elements of the Jacobian matrix J are set to substantially zero. As a result, the robot 10 operates as the extended cartesian robot in which only the four joint mechanisms JEr2, JEr3, JEp1, and JEp2 among the eight joint mechanisms JE are driven.

Compared to the cartesian mode, in the extended cartesian mode, it is possible to move the end section TP1 to a position far from the body BDP. For example, in the cartesian mode, an amount of movement of the end section TP1 in a direction toward the back of the shelf RK is limited to a range of drive of the link LK2 (the movement area ARmv2) relative to the joint mechanism JEr3 (see FIG. 9). In contrast, in the extended cartesian mode, the joint mechanisms JEr2 and JEr3 in addition to the joint mechanisms JEp1 and JEp2 are driven; thus, an amount of movement of the end section TP1 in the direction toward the back of the shelf RK can be greater than that in the cartesian mode.

For example, when the object GD having been conveyed in front of the shelf RK is disposed at the back of the shelf RK, as shown in FIG. 15(c), the robot controller 30 moves the link LK2 in the +X direction by driving the joint mechanism JEp2. As a result, the object GD is conveyed to the inside of the shelf RK. Then, as shown in FIG. 15(d), the robot controller 30 moves the link LK2 in a direction (in FIG. 15, the +X direction) from the front of the shelf RK toward the back by driving the joint mechanisms JEr2, JEr3, JEp1, and JEp2. It should be noted that in FIG. 15, a case is assumed in which the link LK2 is moved in a state in which a posture of the link LK2 relative to the shelf RK and a position of the joint mechanism JEr3 in the vertical direction are maintained.

For example, the robot controller 30 drives the joint mechanism JEr2 to incline the link LK1 such that the end LK1ed2 approaches the shelf RK. In addition, while inclining the link LK1, the robot controller 30 drives the joint mechanism JEp1 to move the joint mechanism JEr3 toward the end LK1ed2 of the link LK1 along the direction De1. As a result, the position of the joint mechanism JEr3 in the vertical direction is maintained. In addition, while inclining the link LK1, the robot controller 30 drives the joint mechanism JEr3 to turn the link LK2 clockwise around the axis Ax3 of the joint mechanism JEr3 as viewed from a point in the direction Dax. As a result, an angle between the direction De2 and the Z-axis is maintained, and the posture of the link LK2 relative to the shelf RK is maintained.

In addition, the robot controller 30 drives the joint mechanism JEp2 to move the link LK2 along the direction De2 such that the position of the object GD as viewed in the Z direction (a position on the X-axis) becomes at a desired position. Then, as shown in FIG. 16, the robot controller 30 drives the joint mechanisms JEr2, JEr3, JEp1, and JEp2 to move the end section TP1 in the downward direction. As a result, the object GD is disposed at the back of the shelf RK.

Thus, in the present embodiment, it is possible to freely switch between the vertical six-axis articulated mode (the first drive mode) and the extended cartesian mode (the fourth drive mode) in which only the four joint mechanisms JEr2, JEr3, JEp1, and JEp2 among the eight joint mechanisms JE are driven. Thus, in the present embodiment, it is possible to substantially prevent control of the robot 10 from being complicated and to substantially prevent a range of movement of the end section TP1 from being narrow.

It should be noted that for the operation of the robot 10 (see FIG. 15(c)) by which the object GD having been conveyed in front of the shelf RK is conveyed to the inside of the shelf RK, the cartesian mode (the second drive mode) may be selected as the drive mode of the robot 10. In this case, for the operation of the robot 10 by which the object GD having been conveyed to the inside of the shelf RK is disposed at the back of the shelf RK, the extended cartesian mode (the fourth drive mode) is selected as the drive mode of the robot 10.

As described with reference to FIG. 8 to FIG. 16, in the present embodiment, by selecting the drive mode, it is possible for the single robot 10 to implement various operations of various types of robots. Thus, in the present embodiment, for example, it is possible to substantially prevent an increase in cost in a case in which a production line is constructed and a reduction in work efficiency.

For example, when a single robot 10 cannot implement an operation of each of a cartesian robot, a selective compliance articulated robot arm, and a vertical articulated robot, so as to construct a production line appropriate for work, it is necessary to prepare various types of robots and to replace a robot in accordance with a change in the work. In addition, some of the various types of robots that are prepared may become unnecessary due to change in the production line. In this case, the cost of constructing the production line increases.

In addition, when a single vertical six-axis articulated robot implements an operation of each of various types of robots, as described above, links (arms) of the robot may be in the way, and the operation may be limited. In addition, when a vertical six-axis articulated robot conducts an operation of a cartesian robot or an operation of a selective compliance articulated robot arm, the operation is complicated because the number of drive axes is large compared to the cartesian robot and the elective compliance articulated robot arm. In this case, a problem such as reduction in operation speed or reduction in operation accuracy occurs. In contrast, in the present embodiment, by selecting the cartesian mode or the SCARA mode, it is possible to operate the robot 10 as a cartesian robot or a selective compliance articulated robot arm. Thus, in the present embodiment, it is possible to substantially prevent reduction in operation speed or reduction in operation accuracy.

As described above, in the present embodiment, the robot system 1 includes the robot 10, which is an articulated robot including seven or more joint mechanisms JE, and the robot controller 30 for controlling the operation of the robot 10. The seven or more joint mechanisms JE may be referred to as an L (L is a natural number of seven or more) joint mechanisms JE. The L joint mechanisms JE are examples of “L joints.”

In a method for controlling the robot 10, the robot controller 30 is configured to receive a selected drive mode among a plurality of drive modes, at least one joint mechanism JE of the plurality of joint mechanisms JE being associated, as a drive target joint mechanism JE, with each of the plurality of drive modes, execute calculation processing including an inverse kinematics calculation to calculate an amount of displacement of the drive target joint mechanism JE identified based on the selected drive mode from among the plurality of joint mechanisms JE, calculate, based on the calculation processing executed, a joint value relating to a state of each of the plurality of joint mechanisms JE such that the robot 10 is in a target state, and control an operation of the robot 10 based on the joint value calculated for each of the plurality of joint mechanisms JE.

In addition, in a method for teaching the robot 10, the robot controller 30 is configured to receive a selected drive mode among the plurality of drive modes, at least one joint mechanism JE of the plurality of joint mechanisms JE being associated, as a drive target joint mechanism JE, with each of the plurality of drive modes, execute the calculation processing including the inverse kinematics calculation to calculate the amount of displacement of the drive target joint mechanism JE identified based on the selected drive mode from among the plurality of joint mechanisms JE, calculate, based on the calculation processing executed, the joint value relating to the state of each of the plurality of joint mechanisms JE such that the robot 10 is in the target state, and generate the joint state information indicative of the joint value calculated for each of the plurality of joint mechanisms JE.

In addition, the robot system 1 includes the robot 10 including the seven or more joint mechanisms JE and including the plurality of drive modes, at least one joint mechanism JE of the plurality of joint mechanisms JE being associated, as a drive target joint mechanism JE, with each of the plurality of drive modes, and the robot controller 30 including the operation controller 33 for controlling the operation of the robot 10, wherein the operation controller 33 is configured to receive the selected drive mode among the plurality of drive modes, execute the calculation processing including the inverse kinematics calculation to calculate the amount of displacement of the drive target joint mechanism JE identified based on the selected drive mode from among the plurality of joint mechanisms JE, calculate, based on the calculation processing executed, the joint value relating to the state of each of the plurality of joint mechanisms JE such that the robot 10 is in the target state, and control the operation of the robot 10 based on the joint value calculated for each of the plurality of joint mechanisms JE.

Thus, in the present embodiment, a drive mode is selected from among the plurality of drive modes, and a drive target joint mechanism JE is identified based on the selected drive mode from among the plurality of joint mechanisms JE. In other words, in the present embodiment, by selecting the drive mode of the robot 10 from among the plurality of drive modes, it is possible to drive only a drive target joint mechanism JE in association with the selected drive mode among the plurality of joint mechanisms JE to control the operation of the robot 10. Thus, in the present embodiment, it is possible for the single robot 10 to implement various operations of various types of robots by appropriately selecting a drive mode of the robot 10 from among the plurality of drive modes.

In addition, in the present embodiment, to calculate the joint value relating to the state of each of the plurality of joint mechanisms JE such that the robot 10 is in the target state, the amount of displacement of the joint mechanism JE selected as the drive target joint mechanism JE from among the plurality of joint mechanisms JE is calculated. Thus, in the present embodiment, when the number of drive target joint mechanisms JE is small, it is possible to reduce a load of the inverse kinematics calculation (an amount of calculation, etc.) compared to a case in which the number of drive target joint mechanisms JE is large. In other words, in the present embodiment, it is possible to reduce a load of the inverse kinematics calculation by appropriately selecting the drive mode of the robot 10 from among the plurality of drive modes. As a result, in the present embodiment, it is possible to substantially prevent a solution to the inverse kinematics calculation from not being calculated within a desired time.

In addition, in the present embodiment, when the plurality of joint mechanisms JE includes a fixity target joint mechanism JE other than the drive target joint mechanism JE, the robot controller 30 (more particularly, the operation controller 33) executes fixity processing by which a joint value for the fixity target joint mechanism JE calculated by the calculation processing is substantially maintained. Thus, in the present embodiment, a joint mechanism JE other than the drive target joint mechanism JE among the plurality of joint mechanisms JE is considered to be the fixity target joint mechanism JE a state of which is unchanged, and the inverse kinematics calculation is executed by use of the drive target joint mechanism JE while the fixity target joint mechanism JE is not moved. As a result, in the present embodiment, it is possible to control the operation of the robot 10 by driving only the drive target joint mechanism JE among the plurality of joint mechanisms JE. In addition, in the present embodiment, since the inverse kinematics calculation is executed by use of the drive target joint mechanism JE among the plurality of joint mechanisms JE, it is possible to substantially prevent a solution to the inverse kinematics calculation from not being calculated within a desired time.

In addition, in the present embodiment, the robot controller 30 (in particular, the operation controller 33) executes the inverse kinematic calculation included in the calculation processing by use of a Jacobian matrix J having a plurality of elements. The fixity processing is processing to maintain the joint value for the fixity target joint mechanism JE by setting, to substantially zero, values of elements for the fixity target joint mechanism JE among the plurality of elements of the Jacobian matrix J. Thus, in the present embodiment, by setting, to substantially zero, the values of the elements for the fixity target joint mechanism JE among the plurality of elements of the Jacobian matrix J, it is possible to easily set the joint value for the fixity target joint mechanism JE to a fixed value. In other words, when the fixity target joint mechanism JE is included in the plurality of joint mechanisms JE, it is possible to calculate the joint value of each of the plurality of joint mechanisms JE by executing the inverse kinematics calculation without changing the number of rows of, and the number of columns of, the Jacobian matrix J, or alternatively, without dividing the Jacobian matrix J into a plurality of matrices.

In addition, in the present embodiment, the plurality of joint mechanisms JE include at least one prismatic joint (joint mechanism JEp). Thus, in the present embodiment, since at least one joint mechanism JEp of the plurality of joint mechanisms JE is a prismatic joint, it is possible to substantially prevent control of the robot 10 from being complicated and to extend a range of movement of the end section TP1 of the robot 10.

In addition, in the present embodiment, the robot controller 30 further includes the display controller 34 for displaying, on the display 38, the operation screen OPS for selecting a drive mode from the plurality of drive modes. Thus, in the present embodiment, it is possible to cause a human operator to easily select a drive mode from among the plurality of drive modes.

In addition, in the present embodiment, the robot 10 includes the body BDP, the link LK1, the link LK2, the end section TP1, the joint mechanism JEr1 configured to rotate at least a portion of the body BDP around a first rotation axis that is the axis Ax1 having an angle of a predetermined angle or less to a direction perpendicular to the bottom BDPbt of the body BDP, the joint mechanism JEr2 connecting the body BDP and the link LK1 to each other and configured to rotate the link LK1 around a second rotation axis that is the axis Ax2 having an angle greater than the predetermined angle to the direction perpendicular to the bottom BDPbt of the body BDP, the joint mechanism JEr3 connecting the link LK1 and the link LK2 to each other and configured to rotate the link LK2 relative to the link LK1 around a third rotation axis that is the axis Ax3 having an angle greater than the predetermined angle to a direction in which the link LK1 extends, the joint mechanism JEr4 connecting the link LK2 and the end section TP1 to each other and configured to rotate the end section TP1 relative to the link LK2 around a fourth rotation axis that is the axis Ax4 having an angle greater than the predetermined angle to a direction in which the link LK2 extends, the joint mechanism JEp1 configured to move the joint mechanism JEr3 relative to the link LK1 along the direction in which the link LK1 extends, and the joint mechanism JEp2 configured to move the link LK2 relative to the joint mechanism JEr3 along the direction in which the link LK2 extends, wherein the end section TP1 includes the first portion TP11 connected to the link LK2, the second portion TP12 connected to the first portion TP11, the joint mechanism JEr5 connecting the first portion TP11 and the second portion TP12 to each other and configured to rotate the second portion TP12 relative to the first portion TP11 around a fifth rotation axis that is the axis Ax5 having an angle greater than the predetermined angle to the fourth rotation axis, and the joint mechanism JEr6 configured to rotate at least a portion of the end section TP1 around a sixth rotation axis that is the axis Ax6 having an angle greater than the predetermined angle to the fifth rotation axis, and wherein each of the plurality of joint mechanisms JE is any one of the joint mechanism JEr1, the joint mechanism JEr2, the joint mechanism JEr3, the joint mechanism JEr4, the joint mechanism JEr5, the joint mechanism JEr6, the joint mechanism JEp1, and the joint mechanism JEp2.

Thus, in the present embodiment, the robot 10, which is an articulated robot including six rotary joints and two prismatic joints, can implement an operation of each of various types of robots.

In addition, in the present embodiment, the plurality of drive modes includes the first drive mode in which the joint mechanism JEr1, the joint mechanism JEr2, the joint mechanism JEr3, the joint mechanism JEr4, the joint mechanism JEr5, and the joint mechanism JEr6 are drive target joint mechanisms JE, the second drive mode in which the joint mechanism JEp1 and the joint mechanism JEp2 are drive target joint mechanisms JE, the third drive mode in which the joint mechanism JEr1, the joint mechanism JEp1, and the joint mechanism JEp2 are drive target joint mechanisms JE, the fourth drive mode in which the joint mechanism JEr2, the joint mechanism JEr3, the joint mechanism JEp1, and the joint mechanism JEp2 are drive target joint mechanisms JE, and the fifth drive mode in which all of the plurality of joint mechanisms JE is the drive target joint mechanism JE. Thus, in the present embodiment, the single robot 10 can conduct an operation of each of various types of robots such as a cartesian robot, a selective compliance articulated robot arm, and a vertical articulated robot.

### 2. Modifications

The present invention is not limited to the embodiment described above. Specific modifications are described below. Two or more modifications freely selected from the following modifications may be combined.

### First Modification

In the embodiment described above, a case is described in which the joint mechanism JEr4 rotates the end section TP1 relative to the link LK2 around a rotation axis that is the axis Ax4 perpendicular to the direction De2 in which the link LK2 extends; however, the present invention is not limited to such an aspect. For example, the joint mechanism JEr4 may rotate the end section TP1 relative to the link LK2 around a rotation axis that is an axis having an angle of the predetermined angle or less to the direction De2 in which the link LK2 extends.

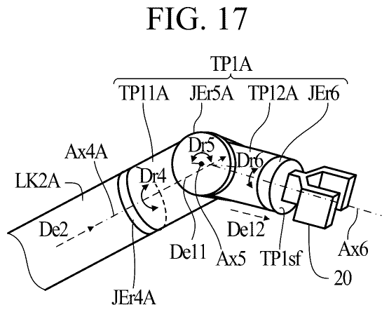

FIG. 17 is an explanatory diagram explaining an example of an end section TP1A according to a first modification. Elements similar to elements described in FIG. 1 to FIG. 16 are denoted by the same signs, and detailed description thereof will be omitted.

For example, the robot 10 according to this modification is the same as the robot 10 shown in FIG. 1 except that a link LK2A, a joint mechanism JEr4A, and the end section TP1A are included in place of the link LK2, the joint mechanism JEr4, and the end section TP1 shown in FIG. 1. The link LK2A is the same as the link LK2 except that in place of the joint mechanism JEr4, the joint mechanism JEr4A is connected thereto.

The joint mechanism JEr4A connects the link LK2A and the end section TP1A to each other and rotates the end section TP1A relative to the link LK2A around a rotation axis that is an axis Ax4A parallel to the direction De2. The rotation direction Dr4 shown in FIG. 17 indicates a direction of rotation of the end section TP1A in a case in which the axis Ax4A is used as a rotation axis. It should be noted that the axis Ax4A corresponds to an axis having an angle of the predetermined angle or less to the direction De2 in which the link LK2A extends.

As in the end section TP1 shown in FIG. 1, in the end section TP1A, the end effector 20 is attached to the end surface TP1sf. The end section TP1A includes a first portion TP11A connected to the link LK2A, a second portion TP12A connected to the first portion TP11A, a joint mechanism JEr5A, and the joint mechanism JEr6. The first portion TP11A is connected to the link LK2A via the joint mechanism JEr4A, for example. Thus, the first portion TP11A is rotated relative to the link LK2A around the rotation axis that is the axis Ax4A.

The joint mechanism JEr5A connects the first portion TP11A and the second portion TP12A to each other and rotates the second portion TP12A relative to the first portion TP11A around the rotation axis that is the axis Ax5 perpendicular to the axis Ax4A. The rotation direction Dr5 shown in FIG. 17 indicates a direction of rotation of the second portion TP12A in a case in which the axis Ax5 is used as a rotation axis.

The joint mechanism JEr6 is the same as the joint mechanism JEr6 shown in FIG. 1. For example, the joint mechanism JEr6 rotates at least a portion of the end section TP1A (for example, the end surface TP1sf) around the rotation axis that is the axis Ax6 perpendicular to the axis Ax5. In an example shown in FIG. 17, similarly to the joint mechanism JEr6 shown in FIG. 1, a front surface of the joint mechanism JEr6 corresponds to the end surface TP1sf. It should be noted that in a configuration in which the joint mechanism JEr6 is included in the second portion TP12A, an end surface of the second portion TP12A may be the end surface TP1sf.

As described above, in this modification, the joint mechanism JEr4A rotates the end section TP1A relative to the link LK2A around the rotation axis that is the axis Ax4A having an angle of the predetermined angle or less to the direction De2. The end section TP1A includes the first portion TP11 connected to the link LK2A, the second portion TP12 connected to the first portion TP11, the joint mechanism JEr5, and the joint mechanism JEr6. The joint mechanism JEr5 connects the first portion TP11 and the second portion TP12 to each other and rotates the second portion TP12 relative to the first portion TP11 around the rotation axis that is the axis Ax5 having an angle greater than the predetermined angle to the axis Ax4A. The joint mechanism JEr6 rotates a portion of the end section TP1 (for example, the end surface TP1sf), to which the end effector 20 is attached, around the rotation axis that is the axis Ax6 having an angle greater than the predetermined angle to the axis Ax5.

In this modification, it is possible to obtain effects that are the same as those obtained by the embodiment described above. For example, in this modification, since the end section TP1 includes the joint mechanisms JEr5 and JEr6, it is possible to cause the robot 10 to conduct various types of work around the body BDP by the joint mechanisms JEr4, JEr5, JEr6, etc.

### Second Modification

In the embodiment and the modification described above, a case is described in which the motor MOr3 for driving the joint mechanism JEr3 is moved with the joint mechanism JEr3; however, the present invention is not limited to such an aspect. For example, the motor MOr3 may be fixed to a predetermined portion of the link LK1 so as to be able to drive the joint mechanism JEr3 even when a position of the joint mechanism JEr3 relative to the link LK1 is changed. In this modification, it is possible to obtain effects that are the same as those obtained by the embodiment and the modification described above.

### Third Modification

In the embodiment and the modifications described above, the robot 10 is described that has a configuration in which the two joint mechanisms JEp1 and JEp2 are added to a vertical six-axis articulated robot; however, the present invention is not limited to such an aspect. For example, the robot 10 may have a configuration in which the two joint mechanisms JEp1 and JEp2 are added to an articulated robot with seven or more axes. Specifically, one or more links LK that differ from the links LK1 and LK2 may be disposed between the body BDP and the joint mechanism JEr2. Alternatively, one or more links LK that differ from the links LK1 and LK2 may be disposed between the joint mechanism JEr4 and the end section TP1. In other words, the robot 10 may include three or more links LK connecting the body BDP and the end section TP1 to each other. In this case, the three or more links LK included in the robots 10 correspond to a plurality of links LK including the links LK1 and LK2.

Alternatively, the robot 10 may have a configuration in which one or each of the two joint mechanisms JEp1 and JEp2 is added to an articulated robot with four or more axes.

As described above, in this modification, it is possible to obtain effects that are the same as those obtained by the embodiment and the modifications described above.

### Fourth Modification

In the embodiment and the modifications described above, a case is described in which by selecting a drive mode, the drive target joint mechanism JE is selected; however, the present invention is not limited to such an aspect. For example, the drive target joint mechanism JE may be selected from among the plurality of joint mechanisms JE without setting the plurality of drive modes to the robot 10, the at least one joint mechanism JE of the plurality of joint mechanisms JE being associated, as the drive target joint mechanism JE, with each of the plurality of drive modes. In this case, for example, the operation screen OPS shown in FIG. 5 may include, in place of the button BTs, a plurality of buttons BT in one-to-one correspondence with the plurality of joint mechanisms JE. The robot controller 30 may select, as a drive target joint mechanism JE, a joint mechanism JE corresponding to a button BT pressed prior to a press of the button BTd among the plurality of buttons BT.

It should be noted that the following aspect is derivable from this modification.

A method for controlling an articulated robot is a method for controlling an articulated robot with L (L is a natural number of seven or more) joints, comprising identifying, as a drive target joint, at least one joint from among the L joints, calculating a joint value relating to a state of each of the L joints such that the articulated robot is in a target state by executing calculation processing including an inverse kinematics calculation to calculate an amount of displacement of the drive target joint identified from among the L joints, and controlling an operation of the articulated robot based on the joint value calculated for each of the L joints.

As described above, in this modification, it is possible to obtain effects that are the same as those obtained by the embodiment and the modifications described above. In addition, in this modification, there is no need to store a drive mode to be selected in advance, and it is possible to greatly increase a variation of selectable joint mechanisms JE.

### 3. Application Example

The robot system 1 including the robot 10 described in the embodiment and the modifications described above may be used for a method for producing an object, the method including assembling components or removing a component.

### 4. Other Matters

Some examples will be described of “turning” and rotation, which are distinguished from each other, briefly described in the foregoing embodiment.

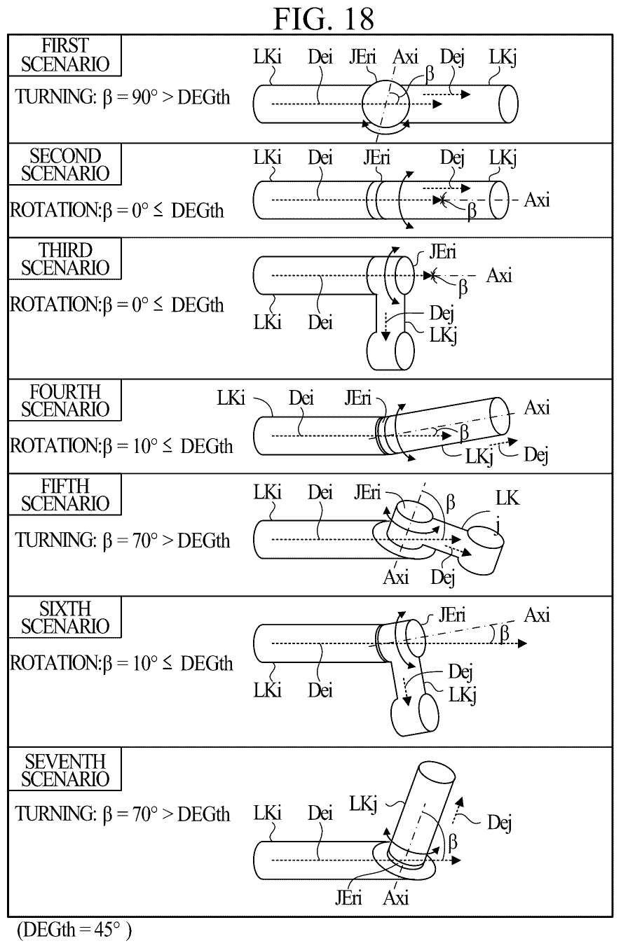

FIG. 18 is an explanatory diagram showing examples of turning. In FIG. 18, turning and rotation, which are distinguished from each other, will be described with reference to connection between two links LKi and LKj that have longitudinal directions that can be recognized. As shown in FIG. 18, an extension direction Dei indicates a direction in which the link LKi extends, and an extension direction Dej indicates a direction in which the LKj extends. In addition, a joint mechanism JEri shown in FIG. 18 connects the link LKi and the link LKj to each other and rotates the link LKj relative to the link LKi around a rotation axis that is an axis Axi.

In the examples shown in FIG. 18, when an angle β between the direction Dei in which the link LKi extends (a specific direction) and the axis Axi is greater than a predetermined angle, rotation around the rotation axis that is the axis Axi corresponds to “turning.” In other words, when the angle β between the direction Dei in which the link LKi extends and the axis Axi is less than or equal to the predetermined angle, rotation around the rotation axis that is the axis Axi corresponds to rotation other than turning (other rotation distinguished from turning).” The “rotation” shown in FIG. 18 represents rotation other than turning. In addition, although the predetermined angle is not particularly limited, in FIG. 18, a case is assumed in which the predetermined angle is 45°. The angle β between the extension direction Dei and the axis Axi is an angle of 0° or more and 90° or less among a plurality of angles that are recognized as angles of the axis Axi relative to the extension direction Dei (for example, four angles formed by two straight lines intersecting each other, or 0° and 180° formed by two straight lines parallel to each other).

In a first scenario, the angle β between the direction Dei in which the link LKi extends and the axis Axi is 90° and is greater than the predetermined angle (45°). Thus, in the first scenario, rotation of the link LKj around the rotation axis that is the axis Axi means turning. In addition, in the first scenario, the direction Dej in which the link LKj extends is perpendicular to the axis Axi. It should be noted that in the first scenario, when the link LKj is rotated (turned) around the rotation axis that is the axis Axi, an angle of the direction Dej in which the link LKj extends relative to the direction Dei in which the link LKi extends is changed.

In a second scenario, the angle β between the direction Dei in which the link LKi extends and the axis Axi is 0° and is less than or equal to the predetermined angle (45°). Thus, in the second scenario, rotation of the link LKj around the rotation axis that is the axis Axi means rotation other than turning. In addition, in the second scenario, the direction Dej in which the link LKj extends is parallel to both the direction Dei in which the link LKi extends and the axis Axi. In other words, the angle of the direction Dej in which the link LKj extends relative to the direction Dei in which the link LKi extends is 0°. It should be noted that in the second scenario, when the link LKj is rotated around the rotation axis that is the axis Axi, the angle of the direction Dej in which the link LKj extends relative to the direction Dei in which the link LKi extends is maintained at 0° and is constant.

In a third scenario, the angle β between the direction Dei in which the link LKi extends and the axis Axi is 0° and is less than or equal to the predetermined angle (45°). Thus, in the third scenario, rotation of the link LKj around the rotation axis that is the axis Axi means rotation other than turning. In addition, in the third scenario, the direction Dej in which the link LKj extends is perpendicular to both the direction Dei in which the link LKi extends and the axis Axi. In other words, the angle of the direction Dej in which the link LKj extends relative to the direction Dei in which the link LKi extends is 90°. It should be noted that in the third scenario, when the link LKj is rotated around the rotation axis that is the axis Axi, the angle of the direction Dej in which the link LKj extends relative to the direction Dei in which the link LKi extends is maintained at 90° and is constant.

In a fourth scenario, the angle β between the direction Dei in which the link LKi extends and the axis Axi is 10° and is less than or equal to the predetermined angle (45°). Thus, in the fourth scenario, rotation of the link LKj around the rotation axis that is the axis Axi means rotation other than turning. In addition, in the fourth scenario, the direction Dej in which the link LKj extends is parallel to the axis Axi, and the angle of the direction Dej in which the link LKj extends relative to the direction Dei in which the link LKi extends is 10°. It should be noted that in the fourth scenario, when the link LKj is rotated around the rotation axis that is the axis Axi, the angle of the direction Dej in which the link LKj extends relative to the direction Dei in which the link LKi extends is maintained at 100 and is constant.

In a fifth scenario, the angle β between the direction Dei in which the link LKi extends and the axis Axi is 70° and is greater than the predetermined angle (45°). Thus, in the fifth scenario, rotation of the link LKj around the rotation axis that is the axis Axi means turning. In addition, in the fifth scenario, the direction Dej in which the link LKj extends is perpendicular to the axis Axi. It should be noted that in the fifth scenario, when the link LKj is rotated (turned) around the rotation axis that is the axis Axi, the angle of the direction Dej in which the link LKj extends relative to the direction Dei in which the link LKi extends is changed.

In a sixth scenario, the angle β between the direction Dei in which the link LKi extends and the axis Axi is 10° and is less than or equal to the predetermined angle (45°). Thus, in the sixth scenario, rotation of the link LKj around the rotation axis that is the axis Axi means rotation other than turning. In addition, in the sixth scenario, the direction Dej in which the link LKj extends is perpendicular to the axis Axi. It should be noted that in the sixth scenario, when the link LKj is rotated around the rotation axis that is the axis Axi, the angle of the direction Dej in which the link LKj extends relative to the direction Dei in which the link LKi extends is changed.

In a seventh scenario, the angle β between the direction Dei in which the link LKi extends and the axis Axi is 70° and is greater than the predetermined angle (45°). Thus, in the seventh scenario, rotation of the link LKj around the rotation axis that is the axis Axi means turning. In addition, in the seventh scenario, the direction Dej in which the link LKj extends is parallel to the axis Axi, and the angle of the direction Dej in which the link LKj extends relative to the direction Dei in which the link LKi extends is 70°. It should be noted that in the seventh scenario, when the link LKj is rotated around the rotation axis that is the axis Axi, the angle of the direction Dej in which the link LKj extends relative to the direction Dei in which the link LKi extends is maintained at 70° and is constant.

Thus, in the embodiment and the modifications described above, rotation referred to as turning is rotation around a rotation axis that is the axis Axi having an angle greater than the predetermined angle to the direction Dei in which the link LKi extends among various types of rotation of the link LKj relative to the link LKi. However, the definition of “turning” is not limited to the above-described examples. For example, in a case in which the foregoing definition of rotation around a rotation axis that is the axis Axi having an angle greater than the predetermined angle to the direction Dei in which the link LKi extends as turning is referred to as a first definition, the following second definition or the following third definition may be used instead of the first definition.

In the second definition, when the angle of the direction Dej in which the link LKj extends relative to the direction Dei in which the link LKi extends is changed by rotation of the link LKj relative to the link LKi, the rotation corresponds to “turning.” Thus, in the second definition, when the angle of the direction Dej in which the link LKj extends relative to the direction Dei in which the link LKi extends is constant during rotation, the rotation corresponds to rotation other than turning. For example, in the second definition, the first scenario, the fifth scenario, and the sixth scenario shown in FIG. 18 correspond to turning, and the second scenario, the third scenario, the fourth scenario, and the seventh scenario correspond to rotation other than turning.

In the third definition, when the angle between the direction Dej in which the link LKj in rotation extends and the rotation axis (the axis Axi) of the link LKj is greater than the predetermined angle, the rotation corresponds to turning. Thus, in the third definition, when the angle between the direction Dej in which the link LKj extends and the rotation axis (the axis Axi) of the link LKj is less than or equal to the predetermined angle, the rotation corresponds to rotation other than turning. For example, in the third definition, the first scenario, the third scenario, the fifth scenario, and the sixth scenario shown in FIG. 18 correspond to turning, and the second scenario, the fourth scenario, and the seventh scenario correspond to rotation other than turning.

In addition, separately from the first definition, the second definition, and the third definition that are described above, based on a relationship between rotation axes of two adjacent joint mechanisms JEr, a relative relationship between two types of rotation by the two joint mechanisms JEr may be defined. Specifically, when an angle between two rotation axes is less than or equal to the predetermined angle (typically, parallel), the two types of rotation may be defined as the same type of rotation, and when the angle between the two rotation axes is greater than the predetermined angle (typically, perpendicular), the two type of rotation may be defined as different types of rotation. It should be noted that the same type of rotation means that both the two types of rotation are turning or both the two types of rotation are rotation other than turning, and the different types of rotation means that one of the two types of rotation is turning, and the other is rotation other than turning. When the definition of the relative relationship between the two types of rotation is used, rotation serving as a base of the relative relationship may be determined based on, for example, any of the first definition, the second definition, and the third definition described above. The first scenario shown in FIG. 18 corresponds to turning in all of the first definition, the second definition, and the third definition, and the second scenario corresponds to rotation other than turning in all of the first definition, the second definition, and the third definition. Thus, it is preferable that the first scenario or the second scenario be used as rotation serving as a base of the relative relationship.

In addition, a definition obtained by combining two or more of the first definition, the second definition, and the third definition may be used. In this case, for example, only rotation corresponding to turning in all of the two or more definitions combined may be used as turning, or alternatively, rotation corresponding to turning in at least one of the two or more definitions combined may be used as turning.

### DESCRIPTION OF REFERENCE SIGNS

1 . . . robot system, 10 . . . robot, 20 . . . end effector, 30 . . . robot controller, 32 . . . processor, 33 . . . operation controller, 34 . . . display controller, 35 . . . memory, 36 . . . communication device, 37 . . . operation device, 38 . . . display, 39 . . . driver circuit, Ax1, Ax2, Ax3, Ax4, Ax4A, Ax5, Ax6, Axi . . . axis, BDP . . . body, BDPbt . . . bottom, BDPba . . . base part, GD . . . object, JEr1, JEr2, JEr3, JEr4, Jer4A, JEr5, JEr6, JEri, JEp1, JEp2 . . . joint mechanism, JEp11, JEp21 . . . thread, JEp12, JEp22 . . . nut, JEp13, JEp23 . . . connection, JEp13a, JEp23a . . . slider, JEp13b, JEp23b . . . support, JEp14, JEp24 . . . rail, JEp14a, JEp14b, JEp24a, JEp24b . . . rod-shaped member, JEr11, JEr21, JEr41, JEr51, JEr61 . . . rotor, JEr12, JEr22, JEr42, JEr52, JEr62 . . . housing, LK1, LK2, LK2A, LKi, LKj . . . link, MOr1, MOr2, MOr3, MOr4, MOr5, MOr6, MOp1, MOp2 . . . motor, RK . . . shelf, TY1, TY2 . . . tray.

What is claimed is:

1. A method for controlling an articulated robot with L (L is a natural number of seven or more) joints, comprising:
receiving, by a computer device, a selected drive mode among a plurality of drive modes, wherein at least one of the L joints is associated, as a drive target joint, with each of the plurality of drive modes;
executing, by the computer device, calculation processing including an inverse kinematics calculation to calculate an amount of displacement of the drive target joint identified based on the selected drive mode from among the L joints, and calculating, by the computer device and based on the executing the calculation processing, a joint value relating to a state of each of the L joints such that the articulated robot is in a target state; and
controlling, by the computer device, an operation of the articulated robot based on the joint value calculated for each of the L joints.

2. The method for controlling the articulated robot according to claim 1, further comprising:
based on the L joints including a fixity target joint other than the drive target joint, executing, by the computer device, fixity processing by which a joint value for the fixity target joint calculated by the calculation processing is substantially maintained.

3. The method for controlling the articulated robot according to claim 2,
wherein the computer device executes the inverse kinematics calculation included in the calculation processing by use of a Jacobian matrix including a plurality of elements, and
wherein the fixity processing is processing to maintain the joint value for the fixity target joint by setting, to substantially zero, values of elements for the fixity target joint among the plurality of elements of the Jacobian matrix.

4. The method for controlling the articulated robot according to claim 1, wherein the L joints include at least one prismatic joint.

5. A robot system comprising:
an articulated robot including L (L is a natural number of seven or more) joints and including a plurality of drive modes, wherein at least one joint of the L joints is associated, as a drive target joint, with each of the plurality of drive modes; and
a controller including an operation controller configured to control an operation of the articulated robot,
wherein the operation controller is configured to:
receive a selected drive mode among the plurality of drive modes;
execute calculation processing including an inverse kinematics calculation to calculate an amount of displacement of the drive target joint identified based on the selected drive mode from among the L joints, and calculate, based on the calculation processing executed, a joint value relating to a state of each of the L joints such that the articulated robot is in a target state; and
control the operation of the articulated robot based on the joint value calculated for each of the L joints.

6. A robot system comprising:
an articulated robot including L (L is a natural number of seven or more) joints and including a plurality of drive modes, wherein at least one joint of the L joints is associated, as a drive target joint, with each of the plurality of drive modes; and
a controller including:
an operation controller configured to control an operation of the articulated robot; and
a display controller configured to display, on a display, a selection screen for selecting a drive mode from among the plurality of drive modes,
wherein the operation controller is configured to drive the drive target joint identified based on a drive mode selected via the selection screen to control the operation of the articulated robot such that the articulated robot is in a target state.

7. The robot system according to claim 5,
wherein the articulated robot includes:
a base;
a first link,
a second link,
an end section,
a first drive mechanism configured to rotate at least a portion of the base around a first rotation axis that is an axis having an angle of a predetermined angle or less to a direction perpendicular to a bottom of the base;
a second drive mechanism connecting the base and the first link to each other and configured to rotate the first link around a second rotation axis that is an axis having an angle greater than the predetermined angle to the direction perpendicular to the bottom of the base;
a third drive mechanism connecting the first link and the second link to each other and configured to rotate the second link relative to the first link around a third rotation axis that is an axis having an angle greater than the predetermined angle to a direction in which the first link extends;
a fourth drive mechanism connecting the second link and the end section to each other and configured to rotate the end section relative to the second link around a fourth rotation axis that is an axis having an angle greater than the predetermined angle to a direction in which the second link extends;
a first movement mechanism configured to move the third drive mechanism relative to the first link along the direction in which the first link extends; and
a second movement mechanism configured to move the second link relative to the third drive mechanism along the direction in which the second link extends,
wherein the end section includes:
a first portion connected to the second link;
a second portion connected to the first portion;
a fifth drive mechanism connecting the first portion and the second portion to each other and configured to rotate the second portion relative to the first portion around a fifth rotation axis that is an axis having an angle greater than the predetermined angle to the fourth rotation axis; and
a sixth drive mechanism configured to rotate at least a portion of the end section around a sixth rotation axis that is an axis having an angle greater than the predetermined angle to the fifth rotation axis, and
wherein each of the L joints is any one of the first drive mechanism, the second drive mechanism, the third drive mechanism, the fourth drive mechanism, the fifth drive mechanism, the sixth drive mechanism, the first movement mechanism, and the second movement mechanism.

8. The robot system according to claim 7,
wherein the plurality of drive modes includes:
a first drive mode in which the first drive mechanism, the second drive mechanism, the third drive mechanism, the fourth drive mechanism, the fifth drive mechanism, and the sixth drive mechanism are each the drive target joint;
a second drive mode in which the first movement mechanism and the second movement mechanism are each the drive target joint;
a third drive mode in which the first drive mechanism, the first movement mechanism, and the second movement mechanism are each the drive target joint;
a fourth drive mode in which the second drive mechanism, the third drive mechanism, the first movement mechanism, and the second movement mechanism are each the drive target joint; and
a fifth drive mode in which all of the L joints is the drive target joint.

9. The robot system according to claim 6,
wherein the articulated robot includes:
a base;
a first link,
a second link,
an end section,
a first drive mechanism configured to rotate at least a portion of the base around a first rotation axis that is an axis having an angle of a predetermined angle or less to a direction perpendicular to a bottom of the base;
a second drive mechanism connecting the base and the first link to each other and configured to rotate the first link around a second rotation axis that is an axis having an angle greater than the predetermined angle to the direction perpendicular to the bottom of the base;
a third drive mechanism connecting the first link and the second link to each other and configured to rotate the second link relative to the first link around a third rotation axis that is an axis having an angle greater than the predetermined angle to a direction in which the first link extends;
a fourth drive mechanism connecting the second link and the end section to each other and configured to rotate the end section relative to the second link around a fourth rotation axis that is an axis having an angle greater than the predetermined angle to a direction in which the second link extends;
a first movement mechanism configured to move the third drive mechanism relative to the first link along the direction in which the first link extends; and
a second movement mechanism configured to move the second link relative to the third drive mechanism along the direction in which the second link extends,
wherein the end section includes:
a first portion connected to the second link;
a second portion connected to the first portion;
a fifth drive mechanism connecting the first portion and the second portion to each other and configured to rotate the second portion relative to the first portion around a fifth rotation axis that is an axis having an angle greater than the predetermined angle to the fourth rotation axis; and
a sixth drive mechanism configured to rotate at least a portion of the end section around a sixth rotation axis that is an axis having an angle greater than the predetermined angle to the fifth rotation axis, and
wherein each of the L joints is any one of the first drive mechanism, the second drive mechanism, the third drive mechanism, the fourth drive mechanism, the fifth drive mechanism, the sixth drive mechanism, the first movement mechanism, and the second movement mechanism.

10. The robot system according to claim 9,
wherein the plurality of drive modes includes:
a first drive mode in which the first drive mechanism, the second drive mechanism, the third drive mechanism, the fourth drive mechanism, the fifth drive mechanism, and the sixth drive mechanism are each the drive target joint;
a second drive mode in which the first movement mechanism and the second movement mechanism are each the drive target joint;
a third drive mode in which the first drive mechanism, the first movement mechanism, and the second movement mechanism are each the drive target joint;
a fourth drive mode in which the second drive mechanism, the third drive mechanism, the first movement mechanism, and the second movement mechanism are each the drive target joint; and
a fifth drive mode in which all of the L joints is the drive target joint.
